(19) United States
(12) Patent Application Publication
(10) Pub. No.: US 2021/0390420 A1
(43) Pub. Date: Dec. 16, 2021

(54) MACHINE LEARNING OPTIMISATION METHOD

(71) Applicant: SHAPECAST LIMITED, London, Greater London (GB)

(72) Inventor: William Barnett, London (GB)

(21) Appl. No.: 17/181,568

(22) PCT Filed: Aug. 21, 2019
(86) PCT No.: PCT/GB2019/052354

§ 371 Date: Feb. 22, 2021

(30) Foreign Application Priority Data
Aug. 21, 2018 (GB) 1813561.6

(51) Int. Cl. G06N 3/12; G06N 5/02; G06F 16/901

(52) U.S. Cl. CPC G06N 3/126; G06F 16/9024; G06N 5/02

(57) ABSTRACT

Embodiments provide a computer implemented method for use in self-optimising a complex time varying system, the method being performed in relation to a first model of the system. The first model is a weighted graph based model. The model comprises: nodes representing an element of the system and being associated with data records indicative of the properties of the element of the system; links connecting pairs of nodes, each link indicating the relationship between a pair of nodes. The method comprises: performing a query to determine a property of the system by performing a traversal along a path from a start node to an end node of the first graph via intermediate node(s) according to the links stored in a data storage structure, the traversal comprising collecting data records associated with each of the start and end node and determining the property of the system based on the data records.

### CROSS-REFERENCE TO RELATED APPLICATIONS

The present application claims priority to PCT Patent Application PCT/GB2019/052354 filed on Aug. 21, 2019, entitled “MACHINE LEARNING OPTIMISATION METHOD” the entire disclosure of which is incorporated by reference herein.

### TECHNICAL FIELD

The present invention relates to the optimisation and analysis of complex systems. Specifically, embodiments of the present invention relate to the development and assessment of performance of a complex system within its operating environment in the context of artificial intelligence and machine learning.

### BACKGROUND

Complex systems exist in many aspects of modern life. A complex system is a term having a specific meaning in the fields of mathematics and computer science (for example in complexity theory). A complex system is a system composed of many components which may interact with each other. The components of the system may be physical entities (e.g. electrical components), software modules or any type of entity that interacts with other entities within the system or with the real world. Examples of implementations of complex systems include self-driving vehicles, robots, artificial intelligence systems and any type of self-learning system.

“Complex system” may refer to any system featuring a large number of interacting components (agents, processes, etc.) whose aggregate activity is nonlinear, or not derivable from the summations of the activity of individual components, and that typically exhibits hierarchical self-organization under selective pressures.

In certain cases it is useful to represent a complex system as a network or graph where the nodes represent the components of the system and the links their interactions or relationships between node. The term may apply to systems represented by “fully connected” graphs in graph theory, or to complex adaptive systems. Each record stored in a node is an instance or observation of a component in the real-world system that the model represents.

A graph database is a data representation which employs nodes to represent entities or elements of a modelled system, and links (also known as edges or arcs) between nodes to represent relationships between those entities. An element of a system is an aspect or component of the system about which it is desired to capture information in order to model that system. Graph databases offer the advantage of naturally presenting “semantic networks” based knowledge representations that can store large amounts of structured and unstructured data. Graph databases are used in a wide variety of different applications. Complex systems that comprise of a large number of elements relationally connected to one another lend themselves to graph-based modelling. Applications include areas such as artificial intelligence, intelligent decision support and self-learning. Graph based models also lend themselves to analysis over such complex systems.

The enormous volume of data that can be encapsulated in graph-based databases creates potential for automated or semi-automated analysis that can not only reveal statistical trends but also discover hidden patterns and distil knowledge out of data. Graphs and graph-like representations provide a very good instrument to simulate or model complex systems as an ontology with entities and relationships among entities.

A problem with analyzing complex systems is that most optimisation techniques depend to some extent upon the skill and experience of technical experts to understand the objectives of the optimisation and to then translate those objectives into a revised future model of the system. In doing so, they must understand the entire current state, processes and system elements in order to build a future model. An issue is that the level of complexity across the system and the interaction of systems can make the process extremely complex and requires very deep domain expertise.

Although there exist platforms and methodologies which aim to help model complex systems, and allow the development of future states of a system, such platforms generally only provide a broad framework of techniques that a skilled technician should go through to model and identify potential changes to optimize the model.

Graph based models can be implemented readily on computer systems. For example, the models and methods described herein may be implemented on physical or virtual machines running a standard operating system such as Windows, Linux or other common operating system. The models would be implemented as standard executable code in common languages such as Python, C#, etc.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

Embodiments of the invention may provide a data analytics platform or program that uses a suite of unique algorithms and AI-based approaches to provide a method for optimising a model of a complex system which speeds up the process significantly, provides a level of insight and analysis which was not possible previously and does so with efficient use of computational resources. Embodiments may provide analysis of complex systems/models that can be used for self-learning and optimisation for simulations and AI systems.

In general, a computer system is configured to receive a model of a temporally based, constrained, complex system represented as a series of nodes and links in a graph, optionally specified in a set of related classified domains. The system is configured to execute a method for traversing the nodes to extract data from the data records associated with each node. The computer system may be configured to calculate the performance of the modelled system based on pre-defined traversals. The system may be configured to execute a set of methods for automatically building future models. The system may be configured to execute a method for automatically evolving the future models to determine improved future models. The system may be configured to execute a method for automatically calculating the changes required to migrate between models at particular points in time (e.g. current, intermediate, and future).

According to a first aspect, the invention provides a computer implemented method suitable for use in an overarching method of self-optimising a system that is complex and time varying. The method is performed in relation to a first model of the system. The first model is a weighted graph-based model of the system. The graph may, optionally, be fully connected but constrained. The model comprises: a plurality of nodes, each node representing an element of the system and being associated with, or comprising, one or more node data records. The data records are indicative of the properties of the a specific instance of the element of the system. Each node data record represents an instance of the element of the system and one or more of its associated properties. The model also comprises a plurality of links connecting pairs of nodes, each link indicating the relationship between a pair of nodes. The method comprises: performing a query to determine at least one property of the system by performing a traversal along a path from a start node to an end node of the first graph via one or more intermediate nodes according to the links, which are stored in a common data storage structure such as a table, the traversal comprising collecting one or more data records associated with each of at least the start and end node and determining the property of the system based on the collected data records.

The query is a mechanism for linking information between nodes of interest, and therefore is a mechanism for interlinking relevant information contained in the model. The purpose is to obtain and combine data from two or more nodes by traversal, allowing information regarding the two or more nodes to be derived. As will be explained in more detail herein, queries can be used in a variety of manners to obtain various information about the modelled system. A simple query may relate information generally, collating information between nodes. A performance metric query relates to a specific query. A performance query might comprise a specific path between nodes that produces a value, or data, that can be compared to a performance metric. Generally, queries may be performed by traversing nodes in the model. Generally, all traversals, which are performed to extract data from the model, may be variations of a mechanism of starting with one node, moving to the next in the table and then the next and so on, and collating data from some or all of the nodes. A difference between methods may be whether data is collated from intermediate nodes or not and whether data is filtered along the traversal or not.

As mentioned above, the link data is stored in a data storage structure. This may be in the form of the table, and the term “link table” will be used to refer to this feature herein. However, other data storage structures are possible, and may be substituted for the link table in this description.

The link table may define directed and/or undirected links between the pairs of nodes, the link table optionally comprising a plurality of records, each record being a specific instance of data connecting a source node, identified according to a source node identifier, to a target node, identified according to a target node identifier. The link table may also store an identifier for each link record.

A single link table may define each of the links between each of the possible pairs of nodes (or substantially all links for substantially all pairs). It is, however, optionally possible that for some embodiments the link data records may be divided or distributed across two or more link tables. In this case only a subset of at least two or more of the links are stored in the common data storage structure. Other link records within the model may be stored in other data storage structures with one or more other link records.

In traditional relational models, related schemas are created with a number of many to many relationships which have to be navigated via mapping tables. These involve using traditional relational complex joins between entities via the mapping tables.

In contrast, according to embodiments, only one link table may be used for node traversal, and the link table contains all the link information which can support complete paths supporting each query. Each path can be wholly traversed by looking up a single, highly indexed, linked path in only the link table. Thus, all the complex joins between separate mapping to link tables are removed from the processing, and searches between nodes can be performance optimised using a look up index. This makes for radically improved performance and greatly reduced in-memory requirement for each analytical query. This allows for significantly more complex models to be represented in a computationally efficient method.

Optionally the common data storage structure, i.e. the link table, also includes the data records associated with the nodes. By storing the node data records in the same data storage structure that stores the link data records, optionally in a flat database format, embodiments of the invention provide improved computational performance when performing queries to derive information from the model. Different link data records could be stored in different link tables to other link data records, as indicated above, provided data for a given link is stored in the same data structure as the node data for the node (or nodes) connected by that link.

In particular, each record in the link table may further comprise a representation of the copy of the source and target node records associated with (i.e. connected to) the link. Optionally the link table node record information is stored in compressed textual format or similar compact, and computationally efficient, format. For example, the records are optionally stored in textual/notation/binary format, in notation and/or compressed such that they are smaller than the source format, as this leads to computational advantage. In view of these features, data can be parsed extremely rapidly if required and chains of nodes can be traversed quickly whereby the data in each associated link record can be interrogated rapidly and in fast access memory because it is more compact. Each entry in the link table may include both the data associated with the node to which that entry refers, and the data associated with any nodes linked to that node. Each entry may contain the source node identifier, the target node identifier, the weighting of the link (representing the strength of one or more attributes of the link) and a representation or copy of the source and target records represented by the respective node IDs. By storing the links in a link table, it is also possible to take advantage of relational indexing which is highly performant for searching very large quantities of data in relational tables. This means that when finding related nodes, the data in those nodes is retrieved rapidly and allows very large data sets to be supported efficiently.

The node records may be stored in the link table in, for example, JavaScript Object Notation (JSON) format or other simple representational formats and similar human or machine-readable (binary or textual) notation and may be used as a highly compact way of representing the records for the purposes of embodiments of the invention. Use of JSON is not essential, although relational databases that may be used in embodiments of the invention, such as SQL based databases, may have inbuilt processing for JSON, which is highly optimised. Any notation, if sufficiently effective and efficient will work. JSON is just one example of a textual format that can be used with embodiments of the invention in a computationally efficient manner. Other options include XML, although XML, may contain lots of tag information making it less efficient.

One or more separate node data storage structures, such as node tables, may also be provided which store the data records for each node. This is sometimes referred to as the source format for the node data records. A single data structure/node table may be used for all nodes, or different data structures/node tables may be provided for each node. A node table is an indexed table that allows the node data to be looked up and can be used for general queries of the model. It may be a table specifying the node, the identifier for each node record and the associated data. It is distinct from the link table, which can also store the node data but does so in a different format that is faster to copy.

Optionally the model further comprises a “link-type” data storage structure, such as a table, that constrains the number of paths that can be traversed by defining valid links between pairs of nodes. The term “link-type table” will be used to refer to this feature herein, but other data storage structures are possible that perform the same function, and may be substituted for the link-type table in this description.

A restriction on which nodes are allowed to be related constrains the model from all possible relationships to just those that are valid, during a traversal. The link-type table may effectively act as a white list of permitted paths, with links optionally, as default, being non-traversable. This mechanism is used to constrain the set of possible relationships to a smaller set based on domain knowledge of what is meaningful in the usage of the model. This allows dynamic queries to be made whilst reducing the amount of processing resources required to perform such queries. Reduction of search space in this manner has two benefits. Firstly, it reduces time to execute a known path by guiding the navigation. Secondly, it reduces the computation processing and memory overheads required to perform the computation. First order paths (i.e. connections of one node to any other node) means that for a simple fully connected 5 node model there are 5 factorial (5*4*3*2*1)=120 possible first order paths. For a 120-node network this would mean 3.85×10285 first order paths which would take an impractical amount of time to search unless constraints are applied. In fact, higher order paths would generally be used for queries (e.g. up to 8th order paths—i.e. traversing 8 nodes for a single analytic query). The permutations for this are correspondingly larger.

Optionally the method may comprise loading model data from one or more external sources into the nodes and/or into the weights in the links between nodes and node data. Loading information into links comprises populating the link table with the relevant data.

Optionally the method further comprises determining at least one of the properties of the system for each of one or more alternative candidate improved, weighted, graph-based models of the system; selecting one of the alternative candidate models based upon the at least one property; and determining the differences between the first model and the selected candidate model by comparing at least a subset of the nodes of the first model with at least a subset of the nodes of the selected model. This allows optimisation to be performed by comparison against candidate potentially improved models. These are candidates for being improved models of the system, which is then determined by testing.

Optionally the one or more data records associated with each node includes a data record indicative of a domain to which the node belongs, such that the nodes are each contained within one or more domains of a set of hierarchically structured domains. The query traversal path may then be limited to nodes within a particular domain. Domains are labels of particular groupings of nodes sharing one or more common properties. Domains are useful when creating self-optimised future versions of models. Each domain can have multiple subdomains. A future model with a parent domain could create multiple models of subdomains which vary slightly. By tagging a group of nodes to a domain, it means that storage requirements are significantly reduced as it is only necessary to store a single parent domain (and all of their associated data) alongside multiple subdomains, some or all of which could vary to make up the alternate candidate improved models. An alternative would be to store each parent domain and its subdomain for each future model, thereby taking excessive storage for parent domains. Furthermore, use of domains makes for a more compact and efficient way of searching for and identifying a subject (e.g. when optimising all nodes in the part of the model related to a particular system functionality). Querying efficiency and storage efficiency are the net result.

Optionally, the property of the system being determined by performing the query is a performance metric of the model. The performance metric may be normalised, taking into account the number of node data records within a given model, whereby the performance metric is made independent of the number of node data records contained within a given model.

Determining the performance metric may comprise: when traversing the path from the start node to the end node, collecting data records of a predetermined type, the predetermined type being defined by the query; combining the values of the data records collected for each traversed node; and scaling and/or normalising the combined value. Selecting one of the alternative models based on the performance metrics comprises comparing the determined performance metric for the first model with corresponding performance metric values for the one or more alternative models. This aspect is specific to a performance query because it can be used to normalise performance against future models and to determine if a future model's performance exceeds that of the current model.

Scaling the combined value may optionally further comprise determining the highest value and the lowest value that the combined values of the data records of the predetermined type may reach over the traversal path and scaling the combined value based upon the highest and the lowest values. The scaling may include normalising the scaled values to a percentage value based upon the highest and lowest values. Absolute (non-scaled) performance may also be valid as a comparison method.

Optionally creating the one or more alternative graph-based models may be performed by altering the first model and/or obtaining data from an external reference source and generating a model using the external data. In particular, the first model may be altered by: (i) replacing one or more nodes in the first model with a sub-model comprising one or more nodes from a pre-determined collection of sub-models, the sub-models each comprising predetermined data indicative of the predetermined property of the system for the sub-model; (ii) determining, for the altered first model, the at least one property of the system by determining the property for the nodes that are not replaced and combining with the predetermined property of the sub-model; (iii) comparing the combined property to the corresponding property for the first model; and based on the comparison, storing the altered first model or repeating steps (i) to (iii) with a different sub-model from the pre-determined collection.

Optionally the first model may be altered by first creating a plurality of copies of the first model, and then altering each copy in a different way. The plurality of copies may be created by: copying the parent link table from its current storage location to working memory; and generating a plurality of copies of the link table by copying the parent link table in the working memory. The current storage location of the parent link table may be persistent storage or it may be already loaded into working memory. The plurality of copies of the link table will each include the node data records in JSON or similar format, which is computationally more efficient to copy than the node table(s) and can be used to subsequently recreate the node tables for any of the children (the copies) for subsequent indexed queries of the resulting models.

Optionally the first model may be altered by identifying the nodes of the first model to be changed to generate the one or more alternative graph-based models; allocating sufficient space in working memory (e.g. RAM) to accommodate the nodes to be changed; copying from the first model, into the allocated space in working memory, the node data for the nodes to be changed; modifying the copied nodes; determining, for only the modified nodes, the at least one property of the system; comparing the determined property to the corresponding property of the corresponding set of nodes of the first model; and based on the comparison, copying the node data for the remainder of the nodes into the working memory or deleting the node data for the changed nodes from working memory. In particular, the nodes may be copied and modified many times and the highest performing subset of nodes is retained, whereas poorer performing subsets of nodes are discarded, based on the determined property.

Optionally, the method may further comprise performing an evolutionary optimisation by: i) generating a set of alternative graph-based models from a seed model or by applying one or more variations to a current model; ii) determining at least one performance metric for each of the models in the set; iii) determining the best performing model within the set based on the performance metrics; and repeating steps (i) to (iii) a plurality of times, replacing the seed model, or the current model, with the best performing model from step (iii), or a subset of the best performing models (e.g. the top 3 performing models), each time. The performance of the overall system model can be retested to determine if there is an overall performance gain. The evolutionary optimisation may further comprise determining the improvement in the performance metric from the best performing model in the current set of alternative graph-based models over the best performing model in the previous set, and halting the evolutionary optimisation when the improvement, according to the performance metric, is below a predetermined threshold.

The set of alternative graph-based models may be generated by obtaining them from a predetermined library of models. The library may be populated by models and/or sub-models that are shown previously to be highly performant. These models and/or sub-models are retained so that they can be rapidly re-used in certain circumstances and rapidly tested. The alternative models can be created from the current model and then refined by replacing sets of nodes with nodes from the library sub-models or some other seed reference model.

Optionally the evolutionary optimisation further comprises determining the improvement in the performance metric from the best performing model in the current set of alternative graph-based models over the best performing model in the previous set, and halting the evolutionary optimisation when the improvement, according to the performance metric, is beyond (e.g. below) a predetermined threshold.

Optionally, the step of determining at least one performance metric for each of the models in the set comprises: traversing through each model in the set and determining the performance metric cumulatively based at least on the nodes that have been varied over the current model; for each node traversal, comparing the cumulative performance metric for the model with the performance metric for the current model; ceasing further processing of the model currently being traversed if the cumulative performance metric indicates a lower performance than the current model.

Optionally, determining the differences between the first model and the selected model comprises, for each data record of at least a subset of the nodes in the first model: determining if a corresponding data record exists in the selected alternative model; and updating a change table to indicate whether: the data record exists in the alternative model; if it has been modified; or if it has been deleted. Changes are therefore noted for additions, modifications or deletions. Determining the differences between the first model and the selected model may comprise: for each data record of at least a subset of the nodes in the selected model: determining if a corresponding data record exists in the first model; and updating the change table to indicate whether the data record exists in the first model.

Optionally the model further comprises: an analytic query path data structure which defines one or more pre-defined paths between pairs of nodes, and that defines one or more node types. Performing a traversal along a path may then further include: looking up one or more records within the first node of one of the pre-defined traversal paths; and storing records within the links of at least the first and last node in the pre-defined traversal path. The method may further comprise filtering stored records out while performing the traversal, or after the traversal, if they meet a predetermined condition. The analytic path is the predetermined path that can either just analyse data at the start and end of the paths or it can aggregate the data in one or more nodes along the path, and particularly may aggregate all the data in all nodes along the path. The mechanism involves starting with one node, moving to the next node defined in the table and then the next, and so on. Data associated with intermediate nodes may be collated or not, and data may optionally be filtered out along the traversal depending upon node data or node classification. The use of pre-defined paths is based on objectives which may be specified by a link-type table. As explained above, only a single data structure (a link table) is needed for traversal, that data structure containing all the link information which can support complete paths. Each path can be wholly traversed by looking up a single table, or a relatively small set of tables in some embodiments. Thus, all the complex joins to link tables are removed from the processing. This makes for radically improved performance and greatly reduced in-memory requirement for each analytical query. Furthermore, results can be cached offline and retrieved rapidly as a result as a static flat dataset.

Ultimately, the method may further comprise adjusting one or more parameters in a physical system in accordance with the determined differences between the first model and the selected candidate model, and thus improving the physical, real-world, system.

Embodiments of the invention may implement any of the methods described herein on one or more computing devices. Embodiments may be implemented as one or more computer program comprising instructions that, when executed by a system comprising one or more computer devices, causes the system to carry out any of the methods described herein.

Advantages associated with embodiments may include improved scalability. Because of the modelling approach whereby links are abstracted in to a relational model, it is possible to scale the number of node types (which represent concepts supported by the system) extremely efficiently. Thus, it is possible to represent any environment in detail. This allows the representation of a complex system in detail rather than a reduced, abstracted version of the model which is commonplace when using typical relational models. Embodiments therefore enjoy the benefits of the highly interrelated graph model matched with the high performance and efficiency benefits of highly indexed relational databases whilst maintaining a very large level of data richness or detail.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 is a high-level representation of an example model used in embodiments of the invention;

FIG. 2 is an example of an undirected weighted graph of the sort that may be used to model a system in embodiments of the invention;

FIG. 3 illustrates an optional method of populating a model with data;

FIG. 4 is an example of a traversal within a traditional graph model;

FIG. 5 is an example of an equivalent traversal to FIG. 4 according to an embodiment of the invention;

FIG. 6 is an example of the generation of future models used in an optimisation process;

FIG. 7 is an example showing the selection of generated models over generations in an optimisation process;

FIG. 8 is an example illustrating change detection between models;

FIG. 9 is an example illustrating change detection between multiple iterations of models;

FIG. 10 is an example of a model used in a particular example of a model optimisation process;

FIG. 11 is an aspect of the model of FIG. 10 where two nodes are used to represent sensors and integrations of data between sensors;

FIG. 12 shows an alternative representation to FIG. 10 in which one particular sensor node holds data required by other nodes of the system;

FIG. 13 is an example of a performance parameter weighting calculation in relation to the model of FIG. 10;

FIG. 14 is an example of a performance parameter weighting calculation in relation to the model of FIG. 12;

FIG. 15 is an example of a method of calculating a performance metric for a model;

FIG. 16 is an alternative example to the method of FIG. 15;

FIG. 17 is an example of a method for creating copies of a parent graph model of a system;

FIG. 18 is an example of an alternative method for creating copies of a parent graph model of a system;

FIG. 19 is an example method of performance assessing a model;

FIG. 20 is an alternative example method of performance assessing a model;

FIG. 21 is an example of a method for creating variations of a parent graph model of a system;

FIG. 22 is an alternative example of a method for creating variations of a parent graph model of a system; and

FIG. 23 is an alternative example of a method of creating modified models.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general terms, embodiments of the invention describe methods for use in optimising a complex system that is modelled using a computer system. Optimisation can be achieved by automatically identifying the changes required between a model of an existing system and an optimised model of the system in order to optimise the complex system. Applications include self-learning artificial intelligence systems operating in an environment in which conditions change over time. Examples would include autonomous vehicles that execute machine learning to adapt their configuration (suspension, handling, braking parameters etc.) to particular road conditions, or that are learning to navigate through an environment with the ability to improve performance over time.

The computer implemented method broadly comprises providing a computer implemented model of the complex system, executing performance analysis on the model to determine one or more values indicative of how well it is functioning in its current environment, testing revised models and determining the performance of the revised models to select the best model, and then determining the changes required to transition from the original model to the selected revised model. The determined changes can then be applied to the original model to improve it, and may also be implemented in the real word system being modelled. The method can be implemented in an autonomous manner, allowing the system to efficiently perform self-learning to arrive at a set of changes needed to optimise the original model.

The underlying model is implemented on the computer system as a weighted graph that is also optionally undirected and/or fully connected. The associated data may be stored in any appropriate form. For example, one or more tables, relational databases and/or graph-based databases may be used.

Embodiments of the invention provide methods of performing the steps associated with the overall optimisation method, which will involve a large number of calculations by virtue of the large number of connections between elements in a complex system. Embodiments also relate to the overall optimisation method itself, which involves processing the large amounts of associated data, stored in a particular data structure, in an efficient manner on the computing system.

Model Description

Overall Model

According to an embodiment, an algorithmic, data-driven, weighted graph-based model is used to represent a complex system and its constituent elements. The model consists of a highly interconnected set of nodes, each of which represents an aspect of the system, and potentially multiple aspects of the system, at a point in time.

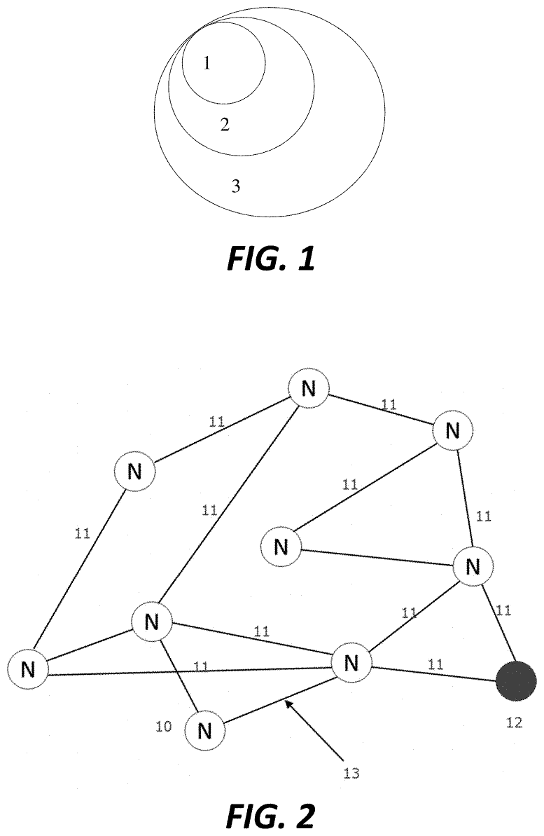

FIG. 1 is a high-level representation of an example model for illustration. A first layer, or domain, may provide the overall definitions and bounds of scope of the overall model. Contained within this are one or more further domains or layers. Each layer may define particular elements relating to the architecture of the modelled system. Nodes of the modelled system, as will be described below, each sit within a domain and are tagged to identify the domain(s) in which they are located.

FIG. 2 is an example of an undirected weighted graph that may be used to model a complex system. Each node N of the graph represents an aspect or element of the system within which the information that is used in the methods described herein is stored. Each node is of a different type, representing a different aspect or element of the system. Each node could potentially be the subject of the analysis described herein. The node data, in the form of node records, may represent instances/observations of entities classified within the node, and their associated properties (e.g. each data record relates to an entity of the modelled system of the type indicated by the node). Each data record stored within the node data structure represents a single instance of that node, being an actual observed instance of the entity falling within the node classification, and its associated properties. As an example, for a networked system, a node may represent all servers within that system, with respective data records being associated with respective servers, and indicating the properties of these servers such as location and physical system resources (storage available, working memory available, processor speed etc). As described herein, the data records may be determined by sensor inputs, or obtained from other sources.

Each link 11 between the various pairs of nodes represents a possible relationship between elements of the complex system, and the weight, or strength, of a link is used to indicate the strength of the relationship between the two nodes that the link connects along with, optionally, other information pertaining to the relationship between the nodes. Each link contains one or more attributes of one or more weightings that indicate specific relationships between the nodes. These weights may change, based on the context of the relationship between the two nodes.

As an example, a link between a braking control application node and a vehicle load (or mass or weight) determining application node within an automated vehicle could be used to represent the manner in which the braking control node responds to instructions issued by the vehicle load determining node in order to optimise braking force for a given weight or mass distribution in a vehicle. The link weight could be used to represent the frequency with which the vehicle load determining node issues instructions to the braking control node, or a control voltage is delivered to specific actuators, etc.

The nodes N can be connected via links 11 within the same scope (i.e. within a common domain) or across domains. Domains are described below in more detail, but generally define groups of nodes having certain common properties. Nodes are used to represent internal elements of a system, but can also be used to represent external elements 12 or aspects of data relating to the external environment in which the modelled system exists. Such external elements may also be important to capture because they may be additional sources of data that can affect performance or analysis of the model.

The external information may come from a variety of external sources that provide information which is valid to augment the model. The information may be provided by, for example, one or more sensors, or static information repositories or other data sets. The data may be provided in any suitable way, such as via the Internet or other suitable network. In whatever manner the data is provided, it can be captured, transformed, integrated and loaded in to the nodes 10, links 11 or as weights in the links between the nodes, as indicated by reference 13.

The external environment information may be generic environment data that is “loaded” in to a model from an external source representing a specific environment from a seed model. One or more sensors could then be used to update the model once real observations are made when the model is operating in its environment and the sensors are providing data relating to operation. The ability to input external information into the model enables the optimisation techniques described herein to be performed for different external environments and external conditions. For example, in the context of an autonomous vehicle, specific terrain information may be loaded into the model, along with operating rules within that terrain, although it may only be when the vehicle is actually operating, and receiving sensor data, that it can work out how to correctly operate within the terrain. As a further example, in the context of an autonomous vehicle an external element may include one or more elements of another autonomous vehicle, and external data may include the weather or road conditions.

The optional “other information” referred to above, pertaining to the relationship between the nodes may include context-specific information based on the types of the nodes. For example, for a node relating to an apparatus or product (node 1) linked to a node relating to users of that apparatus or product (node 2), the link information may include, for each apparatus or product to each type of user, restrictions of the product to the user, or other properties of the product. In the context of an autonomous, self-learning or self-modifying vehicle, the link information could provide constraints on the way one node operates in particular environments. For example, a wheel may only spin to a maximum speed when connected to a particular gear in a certain environment. The link could contain context information, or constraints to be applied.

Generally, each data point about a complex system is stored within a containing node. This node level storage allows a large number of data points to be captured quickly, and to be stored in a highly interconnected model. Node data may be stored in corresponding data structures, such as tables in memory. Each node can store a set of records according to a certain database/table storage schema; different nodes may use different schema to store data. As an example of use of nodes, optimisation may be performed in relation to a system employing software applications used by an entity, e.g. in order to optimise the execution of various software applications on a set of computing resources. There may be numerous (e.g. hundreds) of software applications in the system, and data identifying each application may be captured and stored within one or more nodes that are each structured to store application type data.

Not all nodes need to be connected by links. However, nodes which are connected by links are used to represent valid relationships of interest that may form part of the analysis of the modelled system. The models used can therefore be considered as potentially fully connected, in the sense that all nodes are capable of being linked to all other nodes. In practice, for a given instance of a model, links between relevant nodes for which there is a valid link-type relationship are stored in a link table. This is described below in more detail.

Any instance of captured data is used to represent a system and its interdependent relationships at a point in time. Different instances of a model therefore either represent different systems or the same system at different points in time.

Population of Data

Data from each node may be stored on a physical storage mechanism which could be files, memory or a database in which each node is represented by a separate table or file. According to embodiments, links between nodes are stored in a flattened table (the link table), the entries of which can be indexed for optimal performance. A link table may be a flat database/flat file database, which is a simple database system in which the database is represented as a single table and in which all of the records are stored as single rows of data, which are separated by delimiters such as tabs or commas.

Each node represents a particular concept being represented by the model. Each node may comprise a plurality of data records, each record stored within the node data structure representing a single instance of that structure. The data records may be in the form of rows in a node table within a traditional database schema. Each row refers to one or more properties of an instance of an entity falling within the classification of the node. As an example, in the context of an autonomous vehicle, the “wheels” node may represent all specific instances of wheels which can be used with the vehicle. Each data record may relate to a different instance and have specific properties relating to the instance. Each row would have a unique internal key, ensuring that each record represented in the system can be identified in an index.

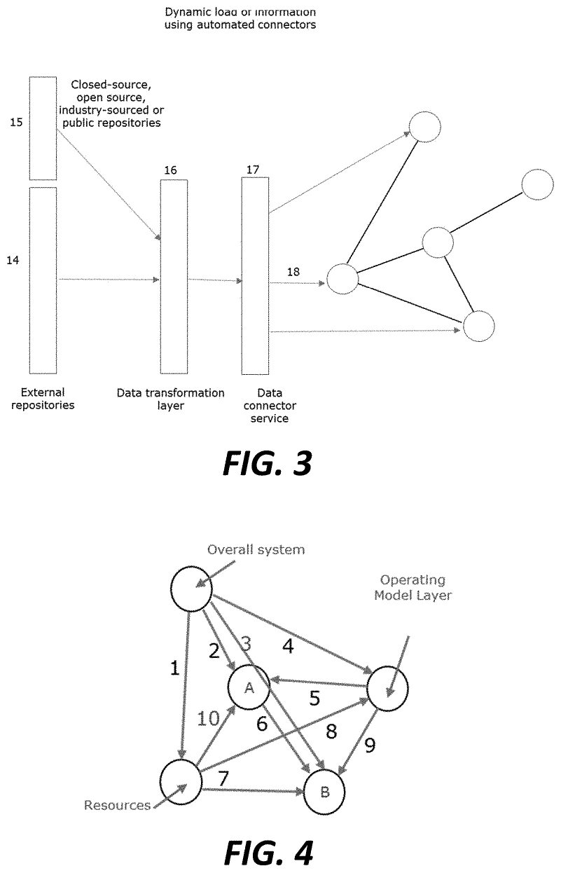

As mentioned above, data may be populated into a given model from external sources. FIG. 3 illustrates an example method of populating a model with data. As shown in FIG. 3, information is captured via one or more integration technologies. These may optionally have pre-built technology connectors 14 that connect to one or more external databases or APIs and extract data of relevance to the model. These APIs or data sources could be open source or freely available and not in a data format which is readily usable by the model. Therefore, once extracted in raw format or in a format specific to the remote system, the data is transformed in to data structures compatible with the connected graph model representation via a data transformation layer. Once transformed, data is loaded into the model directly via an optional data service layer 17. External data can additionally, or alternatively, be captured directly from either closed sources such as industry data providers, open APIs, web sites or data sources, via any appropriate connection (e.g. the Internet), as indicated by reference 15, depending on the information and its source location.

Domains

Domains are attributes of a given set of nodes of the undirected weighted graphs. A domain bounds a set of nodes. Domains may be implemented as specifiers that define the subject or group of a set of nodes having one or more common attributes. They may be used to determine which nodes, or node data records, will be included within a particular query or node traversal as described below. The purpose of the domains is twofold: 1) to enable a set of analytics or traversals to be constrained to a particular set of nodes in an efficient way and 2) to enable different future models to be developed by restricting to a particular area of interest. For example, multiple different walking models for a robotic system may be developed and each one tested for performance against the current overall operating environment domain for the robot to allow machine learning and evolution.

As a further example, any element relating to a particular group of components in a computer network, or electrical system, may be assigned to respective domains. Similarly, tasks involved in image processing, computer vision and any artificial intelligence processes may be assigned to particular respective domains of a system utilising these functionalities. As a further example, within a complex system elements relating to hardware systems, software applications, databases, etc. used within the system may be assigned to a “resource” domain. Any elements that utilise the elements defined within the resource domain, such as entities, terminals, processes etc., may be assigned to a separate domain, such as an “operating” domain. The “operating” domain may be a domain that includes nodes representing functional units, divisions or components of the modelled system, and/or processes carried out by the modelled system, that make use of elements within the “resource” domain in order to perform the ultimate function(s) of the system being modelled. The operating domain may specify the overall functioning system definition for a machine or system, for example specifying the relationship between hardware elements in the resource domain and the processes in the operating domain that use the hardware elements.

A complex system can contain multiple “operating” domains, each of which may be active at some point in time, but not necessarily at the same time. In particular, each operating domain may be a parent domain, containing multiple child sub-domains. The child sub-domains can themselves exist at different points in time, such as the abovementioned resource domains, each of which is also active at different points in time.

By using such a hierarchical domain based model, it allows the creation and modification of specific parts of the model. For example, if desired, only the data records associated with nodes in a particular domain can be changed. In the scenario in which a parent domain may comprise a series of subdomains, some or all of which may be valid, rather than having to create a whole new model and run analytics on each set, as described below, the data associated with nodes in a particular domain can be changed. This reduces the storage and processing requirements of analysing what has changed between different models. This also allows for more efficient searching, as it is easier to create stop conditions on searches based upon pre-specified domains, and the specification of analytics. This means that a search can be specified or tagged as only valid within a particular domain or domains (e.g. run a particular analytic, but ensure that the query does not include nodes beyond the operating domain). That way, the search space is restricted to a single domain and constrained in its extent.

A domain-based model with a relational schema provides benefits over traditional graph models, including an improvement in performance. In traditional graph models attributes of system elements, such as domains, are themselves modelled as distinct nodes, as shown in FIG. 4. Therefore, in traditional graph models, domains are treated as nodes to be traversed when performing searches across nodes, for example. In contrast, in embodiments of the invention, domains can be specified as attributes of nodes, and are stored with the node data. The domains may, in particular, be indexed properties that are linked dynamically. Node data and accompanying domain data are therefore preferably stored within the relational link table described herein. The link table may represent all links for all entities in all domains for a given model. By storing the domains as properties of nodes, these properties can be filtered prior to, during, or after running a traversal.

Each node can be either in or out of a plurality of particular domains at the same time, i.e. domains are overlapping, with child subdomains being inside their parent domains. By specifying these node properties in relation to the nodes themselves the number of operations required to respond to queries made of the modelled system can be radically reduced, making operations on those nodes far more efficient than analytic calculations in traditional graph-based databases.

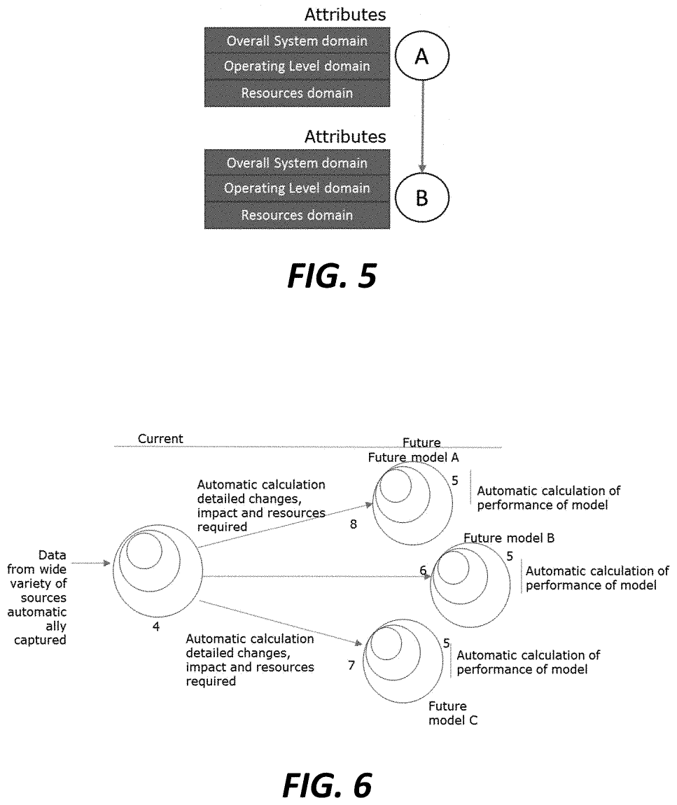

As an example, a query that is run using the model of FIG. 4 to find all nodes that link node A to B in the overall system and having a particular domain specifier requires 10 link operations as indicated by the arrows labelled 1 to 10. Because the number of nodes scales as the model represents higher complexity, the number of link operations required increases exponentially, requiring exponentially more computing resources to complete. In contrast, the same query implemented in a model according to embodiments of the current invention is shown in FIG. 5. Only two operations are required: filtering the nodes where attributes (e.g. domain types) match and traversing the links. Because domains are stored as attributes of a node within a link table these features can be filtered prior to executing the query traversal to retain only nodes having matching selected attributes. As a result fewer link traversals are required for the equivalent query.

Each node is maintained within a hierarchically structured series of domains and subdomains. Each node can reside within any single domain and domains can contain other domains (subdomains). Each node can relate to another node within its own domain or between domains. System elements represented by nodes can be linked across or within domains.

Directionality between nodes may be imposed by a “LinkType” heuristics model, e.g. in the form of a link-type table, wherein definitions define which specific nodes in which specific domains are valid within the model. As a result, the model can be heavily constrained both in terms of valid paths and directionality of the relationships. Effectively this allows modelling a restricted set of relationships in the model itself, rather than imposing limits on physical connections. This makes the model extremely flexible and dynamic, and valid model relationships can be changed dynamically without physical modification. The model may be converted into an undirected graph using a materialised view which can then be indexed performantly.

It should be noted that each node is represented in the link table but as the graph is undirected, there is no particular order in which source and target nodes are represented in the link table. In order that an arbitrary search can be run, the query analytic should be able to locate the relevant source and target nodes in the table. To do this and to avoid the need to always adhere to a particular data structure format in which each source node is written in a specific first column and each target node in a specific second column, the entire link table can effectively be reversed and appended to the original as a set of additional entries. That way, all links are effectively represented in both original form (source node=col1 and target node=col2) but also in reversed format (target node=col1 and source node=col2). Therefore, all undirected links are contained somewhere in the table and can be used for traversal without relying on them being inserted in the right order.

Embodiments may have several advantages over a traditional relational database model structure. One advantage may be in the form of reduced CPU requirements over an equivalent relational model. A model built in a purely relational database model (so called “n-scaling”) would require the model to exponentially grow more complex with each new concept introduced, or nodes added: each node should be capable of being connected to every other node via a dedicated table. Every subsequent query is required to traverse an exponentially increasing number of nodes in the model. By identifying domains using data associated with particular nodes, rather than as distinct nodes, this is no longer the case using the described relational representation for domains.

Another advantage may be that using the described relational representation for domains provides improved speed of computation execution: the use of domains provides improved use of indexes which results in look-ups being executed much more efficiently when there are many relationships to be traversed (in “n-deep” cases). The relative simplicity of the model also makes it easier to maintain as operations can be performed on any model by specifying a domain level operation. For example, any modifications to an entire group or class of actuators of a model could be applied by application at the domain level, rather than querying each node for a particular property or connectivity and then applying the change to each node in the returned result.

Embodiments may have several advantages associated with them over building a model in a purely graphical model where the link relationships (edges) to domains would exponentially grow in number, ultimately making domain nodes into super nodes with the graph becoming difficult to traverse or manage. This is because in such graph-based models each node must be connected to its valid domain node to assure that only nodes valid for particular domains are selected during traversals. In contrast, embodiments of the invention do not link each node in the graph separately to the different domains, but rather each node has a domain parameter associated with it.

Embodiments may use a relational database management system (RDBMS). By using an RDBMS schema, it is possible to heavily reduce the number of nodes which need to be traversed and thereby significantly reduce processing demands, reducing complexity, and improving query performance dramatically. Ultimately, this permits automatic model optimisation to be achieved quickly and efficiently. As a further advantage, speed of queries are improved: using domains as indexed properties means there is no need to link each node to its domain and being in a relational database means indexes can be used to provide fast queries, particularly allowing for fast execution of pre-indexed paths.

Graph Traversal

General

Analytics can be performed using a model populated with data. The purpose of the analytics is to determine at least one property of the modelled system, and this is performed by connecting various nodes within the model to extract information about relationships of interest. Although the analytics or query methods described herein may be used in the determination of performance metrics for comparison with other models, these query methods may also be applied separately to a given model of the sort described herein to provide information to a user or observer about the system.

Analytics generally relate to a particular model and are therefore relevant to the system simulated by that model at a particular point in time. In order to assess the evolution of a system (i.e. compare the current system to the system at a future date), the performance analytics from two separate models must be assessed.

Analytics are created by “walking” or “traversing” through several nodes, starting from a source node via valid links through to a target node. Each different path represents a different set of nodes and node relationships that can be traversed, and will provide a different set of information about the model and, in some cases, about its performance. By analysing the weights of the links between nodes, and the content of the information of each node, different information can be determined because the weights are used to represent different aspects of the strength of the relationship between nodes.

Nodes generally relate to aspects of interest of the system being modelled. As an example, a particular node could represent the wheel type of an autonomous vehicle and another node could represent uphill movement. The weights (which would be defined by using sensor data relating to the vehicle or robot's environment) determine the performance of a particular wheel in allowing the system to move uphill.

The type of relationship represented by a given link is dependent on the source and target node types. Between a source node of a first type and a target node of a second type the link weight could be used to represent a parameter indicative of a first type of relationship between the source and target nodes. However, if the source node is of a third type and/or the target node is of a forth type, the weight could be used to represent a parameter indicative of different types of relationship between the source and target nodes.

As a traversal through the model occurs, the system may also, optionally, employ a system of data filters at each stage of the traversal. Each filter applies a specific rule or data reduction technique which allows the final result set to be reduced further and made highly specific to suit a particular query of interest. By adding filters it is further possible to easily create a complex result-set of data which is difficult to acquire using any other method. For example, the filters may filter to only include in the traversal particular types of data from nodes during the path. Filters provide a way of reducing the volume of data returned and therefore improve the performance of subsequent analysis of the model. By defining the filters at query time, prior to traversing the nodes, only particular data satisfying the filter criteria are obtained from the intermediary nodes, making the traversal more efficient, and the returned data more efficient to process.

As a specific example of an implementation of filters it might be desired, in a networked system, to identify all servers in a specific data centre (e.g. Centre 1) that relate to all of the modelled system's applications of type “X” (e.g. applications that relate to carrying out a particular action X) that support a particular function “Y” of the system. In that case, the traversal query will find the model domain “Y” and all applications related to it. The query will then filter applications by application type “X” and link from that filtered set to all servers where server location=“Centre 1”. Such a filter specification can be set up in the query analytic a-priori.

Traversal paths can be predetermined and a large library of queries can be established to extract specific data about the modelled system. This allows the development of a set of rich methods for analysing the relationships and complexity of a system at a particular point in time, where the system state at a particular point in time is defined dynamically using data captured from external sources such as sensor data or appropriate data repositories as described herein.

Use of these types of traversal paths has several advantages. The model representation described herein is implemented to make model traversal as fast and as efficient as possible, particularly on complex models with large datasets. Without using such models, it would be necessary to traverse the data in traditional ways, such as undirected searches with stop criteria—i.e. to search every possible path until every node in a particular domain has been visited or a particular stop condition is met. Recursive-style searches in graph theory are complicated to specify and expensive in compute power or memory.

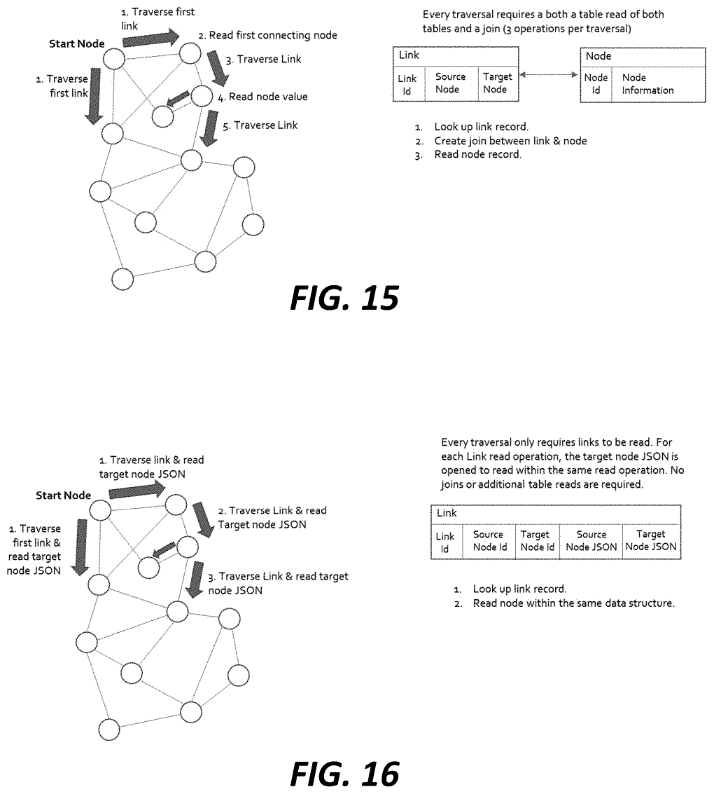

Using only a purely traditional relational model, nodes would be linked together using associative many-to-many (m:m) mapping tables to relate nodes in the case where each node type “a” could relate to a large number of nodes of type “b” and vice versa. Traversal of these relationships involves relational joins between entities via its mapping or association tables, since there will be distinct mappings of links to node information/data using separate tables (as indicated in FIG. 15 for example). In contrast, in embodiments of the invention, all many to many associations are represented by a single link table which abstracts all source to target links in a single indexed table. This link table may be used for traversal; it contains all the link information, and optionally also corresponding node information, which can support complete paths. As a result, each path, and therefore each set of links, can be wholly traversed by looking up a single link table. Thus, all the complex joins to link tables are removed from the processing. This makes for radically improved performance and greatly reduced in-memory requirement for each analytical query.

Although a single link data structure, such as a table, may be used, it is possible to use more data structures. Embodiments may use one or more tables that each define the link information, and optionally also node information, for a first respective node and at least a second respective node, from the complete set of nodes making up the model. Each table would define links and optional node data for a different subset of nodes such that the tables, when combined, contain link data for the entire model. A given link table then defines all the links for at least a subset of nodes in the system, optionally along with the node data. The nodes/links used for each link table may then be arranged such that a given query may only need to refer to a particular table.

A particular manner of implementing the traversal of a system model will now be described.

In order to represent the model a link table is provided. As explained above, the link table is a flat structure which defines every single link between every single node within the modelled system and the weighting associated with each link. Each record inside the link table is a specific instance of data connecting a source node (with a source identifier record) to a target node (with the target node identifier). Along with the source and target IDs, each link may also contain a copy of the source and target records stored in compressed textual format or similar compact format, such as notation, whereby the format is smaller in size than the source format of the node data table(s). The records may optionally be stored in JavaScript Object Notation (JSON) format, although other formats may be used. The record copies can then be parsed extremely quickly if required, allowing chains of nodes to be traversed quickly and the data in each record to be interrogated rapidly if required. In particular this allows the traversal to be performed in working memory (e.g. RAM).

The graph of FIG. 2 is not fully connected because every node is not connected to every other node. Generally all nodes may be fully connected, but the graph being fully connected is not a requirement. Optionally, therefore, a link-type data storage structure, such as a link-type table, may be provided to determine which node links are valid. This table provides a reference that defines which nodes are allowed to be related, and effectively constrains the model from all possible relationships to just those that are valid. This mechanism is used to constrain the set of possible relationships to a smaller set based on domain knowledge of what is meaningful in the usage of the model. The link-type table may contain data records each specifying a source node and a target node. It may also specify the domains of the source and target nodes. Since the link-type table may be an indexed table, it can also specify an ID/key for each link-type data record.

An alternative way of constraining valid links is to not allow nodes to be connected at all. This potentially removes the need for the link-type table but is a less flexible approach.

A further table that may be provided is the “Analytic Query Path Table”. This is a table that defines one or more pre-defined “analytic” or traversal paths of interest. The analytic path is a predetermined path that can be implemented in a number of ways described herein. The traversal paths are implemented by starting with one node, moving to the next defined in the table and then the next and so on until the end of the path is reached. This may involve a look-up of data at the start node and end node of the path only (e.g. a query to find all the servers in the system that are compatible with a particular application). Optionally, data in intermediate nodes can be collated, i.e. all the data in all nodes can be aggregated along the traversal path. Filtering of data along the path may also be applied as described above.

The traversal query results for each node can be aggregated based on pre-defined algorithms. This allows environments to be represented via tangible numbers and meaningful data relating to the elements, domains, and performance of the model. This allows properties of the model to be quantified that are traditionally not quantifiable.

Traversal Examples

Traversal of the model may be achieved in various ways depending upon objectives. A first example of a traversal method is:

Simple navigation—a general search from a source node to a target node, potentially via one or more intermediary nodes, that allows analysis of information in a source node and how it relates to a target node. For example a query, in relation to a modelled network system, may be to find all servers in the system that are used in the execution of a particular software application. Little interest is paid to any intermediary nodes, they are just used to navigate the model.

A predefined query path is read from the Analytic Query Path Table, which holds, for each analytic of interest, a definition of a path through the model. The path may be provided as a relationship map in notation form. An example would be (a,b:b,c:c,d), which specifies a path from node a to b, node b to c and node c to d. The first (source) node type is looked up in the Analytic Query Path Table, and then for each node pair specified in the path the following steps may be repeated as necessary: identify all records connected in the link table of that source node to the next intermediary defined in the path (e.g. find all node data records within node b which are connected to prior node); store linked records; and look up the next intermediary node relationship in the Analytic Query Path.

An example might be a query to find all servers in a networked system (node=servers) that are connected to, or implement, application A (node=applications). The search will find all node data records of a particular type. Filters may then applied as required (e.g. filter to all servers having particular processing capabilities connected to the particular application). What will be returned by the query are specific node records, e.g. a list of specific instances of servers.

Once the traversal is completed, intermediate records can be discarded as required to return source and target records only. This is true when the query only requires data from the leaf nodes. Sometimes it is important to capture all data obtained at every single node.

In more detail, and as a particular example, when implementing a simple navigation traversal, once the Analytic Query Path(s) for the selected analytic are read, the source identifier and the records associated with the source node are stored in memory. For each node pair in the path, the method may further comprise: look up node data records of the node in the link table; identify all node data records connected to the next node as defined in the node pairs; store node data records found (i.e. store source identifier, target identifier); repeat (ii) and (iii) until all node pairs are read; store target identifier and corresponding records; and return source and target identifiers and records.

A second example of a traversal method is:

Collated navigation—collation of all records between all nodes traversed from the source to target on a pre-defined path. Information in all nodes is analysed, collecting the data in related records of nodes as they are navigated. In this instance, all information is collated through all intermediaries, because this information is used to derive additional information. An example query might be, in the context of a modelled networked system, to find all servers and all other devices within the system that are used in the execution of a particular software application.

To perform a collated navigation traversal, the valid paths between entities/nodes are first defined in the link-type table. A predefined query path is read from the analytic query path table, which holds, for each analytic of interest, a definition of a path through the model. Again, the path may be provided as a relationship map in notation form. An example would be (a,b:b,c:c,d), which specifies a path from node a to b, node b to c and node c to d. The first (source) node is looked up in the analytic query path table, and then for each node pair specified in the path the following steps may be repeated as necessary:

Identify all node data records connected in the link table of that source node to the next intermediary defined in the path (e.g. find all node data records of node b that are connected to prior node); store linked records in working memory/RAM or a temporary table in persistent data storage; and look up the next intermediary node relationship in the Analytic Query Path.

In contrast to the simple navigation method, all records for intermediate steps are retained and can be summarised or used as required.

In more detail, and as a particular example, when implementing a collated navigation traversal, once the analytic query path(s) for the selected analytic are read, for each node pair in the path the method may further comprise: look up node data records of the node in the link table; identify all node data records connected to the node data records identified in (i) of the next node as defined in the node pairs; (i.e. find the data records of the node(s) connected to the node data records identified in step (i)); store the node data records that are found (e.g. store source identifier, source records in JSON format, Target identifier, target records in JSON format); cache everything in the result set; (optionally) filter node data records where node data does not meet specific acceptable filter criteria (i.e. filter out the unwanted records for that node) and split the result set down to only the filtered records; repeat (i) to (iii) or (i) to (iv) until all node pairs are read; (optionally) filter stored node data records for specific filter conditions; and return results.

Once the node records are read they are optionally filtered and stored so that the next set of node records can be filtered by the previous set. However, when performing filtered navigation it is more efficient to filter the node data as the model is traversed, since the next set of records for nodes which have been filtered would not be obtained. Filtering after traversal is less efficient because all records need to be read, and only when a full dataset is obtained is filtering applied. It is, therefore, optionally preferable to perform the filtering at step (iv) rather than step (vi).

A third example of a traversal method is:

Filtered navigation—collate the records between a source and target node, but only if they meet a specific filter condition or set of filter conditions. Filtered navigation is a similar method to collated navigation, but at each stage of navigation through intermediary nodes, only information based on a specific filter of data at some or all nodes is returned. In this instance, only records meeting the filter at each intermediary node are collated. An example query, in the context of a modelled network system, might be to find all servers upon which a particular application is executed that are located in a particular data-centre.

To perform a filtered navigation traversal, the valid paths between entities/nodes are first defined in the link-type table. A predefined query path is read from the analytic query path table, which holds, for each analytic of interest, a definition of a path through the model. Again, the path may be provided as a relationship map in notation form. An example would be (a,b:b,c:c,d), which specifies a path from node a to b, node b to c and node c to d. The first (source) node is looked up in the analytic query path table, and then for each node pair specified in the path the following steps may be repeated as necessary: identify all node data records connected in the link table for that source node to the next intermediary defined in the path (e.g. find all node data records of b type that are connected to prior node); store linked records; filter linked records that meet condition; look up the next intermediary node relationship in the Analytic Query Path; or alternatively, collate everything and provide filtering on completion (although this is computationally more expensive and requires more intermediate storage).

In more detail, and as a particular example, when implementing a filtered navigation traversal, once the analytic query path(s) for the selected analytic are read, for each node pair in the path the method may further comprise: look up node data records of the node in the link table; identify all node records connected to node records found in (i) of the next node as defined in the node pairs; reference and filter records (e.g. in JSON format) contained within node records found at (ii) for specific filter condition; store node records found (i.e. store source identifier, target identifier, records associated with nodes in JSON format); once all node pairs are read, filter stored node records for specific filter conditions; and return results.

Dynamic Performance Assessment

In order to determine which of a plurality of models is better adapted to a particular environment, it is necessary to determine how each model performs in its operating environment. In order to do this, the computer implemented system according to embodiments of the invention may determine one or more performance metrics for each model. Generally, this may involve performing a dynamic performance assessment which is based upon the query techniques described above. Performance metrics can provide a variety of different measures of efficiency and performance of the model in a particular environment. These can include (but are not limited to) efficiency, agility, complexity or simplicity of the model, and any other appropriate metric. The precise metric is not important, and may be determined as appropriate for the situation. More important is how the metric value can be determined for a given model.

Each metric is a pre-determined analytic-based algorithm which operates across a pre-determined set of nodes within the model. Each metric is defined to measure different properties of the overall model. Some performance metrics will operate across the entire model and across multiple domains. Others are confined to a smaller subset of nodes or domains. Each specific metric is defined by a unique set of nodes and an ordering of nodes defined by the way in which the particular performance metric is calculated. Each performance metric relates to a path traversed over a unique set of nodes, the path being predetermined based upon the performance metric in question. The metric is determined by navigating through a pre-defined set of node relationship paths, optionally with a particular set of filters applied as described above. A library comprising a plurality of performance metric queries can be established to allow performance metrics for a particular model to be quickly determined. These in turn allow the system to automatically assess its own performance and to evaluate the performance of any two or more models in a particular environment.

This implementation makes it possible to capture and analyse the necessary performance information of the model in near real-time. The automated assessment manner described means improved times to calculate queries such as performance metrics. Performance metrics are based on actual data in the model and therefore are considerably more accurate than any manual counting or estimation model. For large models this calculation is too time consuming and prohibitive to be performed in a non-automated way. It also means that performance metrics for future models and systems can also be calculated rapidly using the same algorithm method. This is the basis for a further aspect of embodiments of the invention which is calculating and identifying optimised future models (see below).

Each performance metric of interest may have at least one parameter or property that takes default metric values. These values may be discrete measurement types representing ranges, or quantised value ranges. Each metric value may be different in meaning and value depending on the system. For example, for a modelled autonomous vehicle system, and the performance metric “agility”, the following values may be assigned: (i) 180, (ii) 150, (iii) 120, (iv) 90, (v) 60, (vi) 30. The numbers, for the agility metric, in this example represent the number of minutes required to change a component (for example a software or hardware module) in the system in order to incorporate a specific capability (for example ABS or wet weather condition driving).

The metric values may be stored in the links between nodes that make up a particular query path relevant to the performance metric being assessed. For instance, if one performance metric for autonomous vehicles connects between nodes relating to actuators, sensors, motors and wheels, the links between data in those node types will have a series of observations. The metric values between all models can be normalised, regardless of size (i.e. the number of node data records within models). Each link may have an associated performance value, having a value somewhere between the highest and lowest possible values. These values can be normalised. For example, a normalised value can be obtained by: normalised value=observed value/(highest possible value−lowest possible value). A standardised normalised performance value can therefore be created across two (or more) models so that like for like performance can be compared.

As before, valid paths between entities are defined in the link-type table. A predefined query path is read from the analytic query path table which holds, for each analytic of interest, a definition of a path through the model corresponding to a particular performance metric. Again, the path may be provided as a relationship map in notation form. An example would be (a,b:b,c:c,d), which specifies a path from node a to b, node b to c and node c to d. The paths needed to calculate a specific metric are predetermined. To define a particular metric may require analysis of all components or nodes having a particular categorisation. For example the “agility” performance metric mentioned above, and in the context of an autonomous vehicle, may be determined by a query of nodes or node data records having a pre-assigned relevant type, such as “replaceable”, indicating that they are relevant to the performance metric. The nodes or node data records may have assigned values indicative of the number of minutes required to change a represented component.

Once the analytic query paths for the selected metric are read, the method may involve the following steps: Read links associated with the query paths until no links remain.

Calculate MAX and MIN metric values related to the performance metric value defined for the links for the selected metric. For example, if calculating “Agility”, calculate the max and min number of minutes needed to change the component. Calculate the max value possible (=number of links multiplied by maximum metric value) and the min value possible (=number of links multiplied by minimum metric value)—typically all links may be set as their minimum metric value.

Calculate the total observed metric values related to the performance metric values defined for the links for the selected metric. For example, if calculating agility, calculate the total number of minutes needed to change the components.

Return performance metric value as a percentage of total value between min value and max value. This may be calculated as ((#max−#min)/(#observed))*100, although this is only one way of normalising the metric, and any similar normalisation could be used depending on the metric being determined to allow comparison of the metric with other models.

As mentioned above, a scaling process may be applied. The maximum and minimum metric default performance metric parameter values may be determined and stored, the maximum parameter value (#maxvalue) indicating the maximum value any given node can have for that parameter and the minimum parameter value (#minvalue) indicating the minimum value any given node can have for that parameter.

The total maximum and minimum performance metric values can then be calculated. The total maximum value “totalmaxvalue”=#maxvalue*(number of nodes traversed). The total minimum value “totalminvalue”=#minvalue*(number of nodes traversed). The performance metric value is then determined as a percentage of the total value between the totalminvalue and totalmaxvalue. This is an example of the scaling that may be applied. Any other appropriate scaling method could be applied as appropriate instead.

Link Based Optimisation

Performance assessing a model can be based on an approach in which each link and node are traversed, and the performance of each node is calculated with the net result of the overall model being the summation of the performance values of each node. An alternative optimisation method, applicable to any embodiment described herein, optimises the calculation of performance across the whole model by only traversing the links defined in the link table.

Rather than traverse each node and link iteratively throughout the model, this optimisation approach uses the link table only, and the compressed, optimised, representation of nodes contained therein, to perform the performance query optimisation. This uses the compressed node records stored in the link table to perform the performance assessment and no joins or computation between tables are required.

FIG. 15 shows a method that requires traversing each node and link iteratively through the model, in which a link table of the sort described herein is not used. The method involves the following steps:

Calculate the performance of the first node by reading data for the node.

Mark the node as being traversed.

Identify subsequent links to nodes.

For each node in the model which is not marked as traversed:

Add the performance of the node to the total model performance

Mark the current node as traversed

Identify the next node to be traversed via the link table.

Each traversal requires both a table read of two separate tables, since the link information is stored separately to the node information. This requires creating a join between the link and the node in distinct tables in order to read the appropriate node record.

FIG. 16 shows an improved method that makes use of the link table described herein. According to this method, the approach is to iterate through each link record, which also contains the representation of the node (optionally in compressed JSON format as described above). Where a node performance is read, its value may be summed additively to the total and the node ID is marked as being recorded in a simple look up table. The method may continue to iterate through the model until all links have been assessed:

For every link record in the link table, capture the associated node data.

Using the node data, calculate the performance of each node.

Record the node index in a recorded value table.

For each node in the link table:

If the node index number does not exist in the record value table

Calculate its performance

Add the performance value in the table.

Every traversal only requires the link entries to be read. For each link read operation, the target node is opened to read within the same read operation. No joins or additional table reads are required.

Whilst this method requires a slight additional overhead in storage to record which nodes have been measured, the ability to iterate through a single table in one operation and removing the need to look up links, read each respective node, then assess its subsequent link represents a significant performance improvement in CPU overhead.

Model Generation and Optimisation

A purpose of embodiments of the system is to be able to self-improve performance over time. In order to achieve this the system creates a series of future models of the system being modelled, each of which can be performance assessed relatively to the current model of the system.

An advantage of embodiments of the invention is the ability to create alternate future models of the system which can be empirically tested using the same data driven approach, and then use data from an external environment to automatically build different future versions of the model, each of which can be tested empirically for performance using the performance metrics. A series of analytics can also be used to determine the changes required to transition from the current state to the optimised future state, allowing the system to self-improve the model's operation in its environment. Embodiments of the invention are therefore able to determine an optimal future version of a system and automatically determine a series of steps needed to improve the current system by using a current model and the associated data alone, in conjunction with machine-learning techniques.

The first step is to create one or more future models of the system. This can be done in two ways. Firstly, by copying the existing model into a future state that can be attributed to a future point in time within the environment. From here, the data nodes and/or links between the nodes are modified either randomly or using external models to represent changes in the structure of the system. Changes to models can be made either at particular domain levels or to the whole model. For example, changes at the scope of a particular domain could include, a resource domain (e.g. changes to the system hardware or software functions within an autonomous vehicle) or can be wholesale changes to the system at its operating domain level (e.g. changes to the way in which the resources in the resource domain are used by the operating system of an autonomous vehicle).

Secondly, a new future model can be created with very limited reference to information contained in the existing model. An entirely new model of nodes, node data and/or links could be defined to represent a new system, or a portion of it, and new detailed operations or operating infrastructure. These could be defined manually or through an approach of dynamic analysis (as described below). In other words, to generate a viable future model, whole parts of the copied existing model could be discarded and replaced with an externally created part. For example, if an autonomous vehicle in the field observes a different way of operating that seems to be effective, that operating method could be adopted by incorporating it into the model.

Once generated, each of the future models are also then assessed using the same performance algorithms described previously. This is shown in FIG. 6. Each of the plurality of future models 5 created is tested algorithmically against the performance criteria as set out above. Their performance values are then compared with each other and compared to the performance criteria of the current model 4, representative of the system at an earlier state than the future models 5. Furthermore, multiple future models could be created, each of which may be built using a different set of data and relationships, and each of which is tested independently 6, 7.

In order to provide accurate and meaningful comparisons between metrics, the automatically created metric values can be normalised across models. The analysis metrics created may, for example, be created as percentages as described above in relation to the normalisation of performance metrics, which assures that performance metrics are normalised regardless of whether this is a predefined copied model or a newly generated model. For example, the model “complexity” performance parameter may be defined as the level of complexity of each node traversed as compared to the overall level of complexity for each node across every possible relationship in the graph. The complexity of each model is therefore described as a percentage, or similar, and can be meaningfully compared to the complexity level of a model at a different point in time.

The priority and importance of the various performance metrics may be predefined based on areas of interest of the model or the strategy of the model in a particular environment. For instance, if the priority for a future system model is to create a new model for a vehicle which is more fuel efficient to operate (fuel efficiency being treated as one of the weighting factors of a node) but also more adaptable to environmental conditions than the current model, then the analytics can be used to determine, for each future state model, which model has the best fitness to the performance criteria. Equally, it may be relevant to change strategy in particular environments and dynamically seek to change the strategy if the speed by which performance increases happen in future models is too low. For example, if a walking robot operating in snow does not gain appreciable performance increases in speed regardless of different models, the strategy might be to seek to optimise different performance criteria based on the level of grip (as defined by the relationship between wheel nodes and track nodes). The importance of the efficiency and adaptability metrics are given greater emphasis than the other metrics available.

The future models are generated by identifying and assessing underperforming aspects of the current model and taking a series of hypotheses or algorithmic approaches in a future model to optimise performance. An alternate model to optimisation can be sought by using externally provided models or information could be constructed into a working model which would provide better performance, as described in more detail below. In each scenario, one (or more) future child models are built which are possible future systems, each of which varies in representation. Each child is then dynamically tested for performance using the techniques described above.

The highest performing child models are selected and child models that do not perform well are discarded (a “winner takes all” style algorithm). The set of future models is therefore restricted to models that provide a performance increase over the current model.

The method can be iterated to continue to optimise the performance by taking each of the future models and trying out different variations of them, using the method above in combination with a genetic algorithm approach, which is described further below. With each successive generation, different hypotheses are tested, or different sub-models are imported from external systems. Each time a new variant is introduced the revised model is re-tested using the same performance criteria. For each new version of the system, the highest performing future model is retained and the weakest are discarded. In following this, a series of future models which are high performing are evolved. This process of evolution and selection can be continued until the respective improvements between parent and child generations reaches a sufficiently small improvement threshold that subsequent optimisation does not warrant any further processing.

Advantageously, this provides the ability to detect underperforming areas of modelled systems based on pre-defined metrics, to automatically evolve the system models to address those areas and detail the changes to the modelled system as the evolution proceeds. This also provides the ability to dynamically build and test future models and test the models for their fitness to perform the desired function. This also provides the ability to continually evolve different versions of future systems until the level of optimisation outweighs the processing overhead (i.e. the number of optimisations is low).

Embodiments provide an improvement in the performance of the model using genetic optimisation techniques, described herein. Using data processing capabilities and the performance testing algorithms it is possible to dynamically build greatly optimised future models of systems automatically using extremely deep analytics. This means radically improved system performance in the future (by picking the best fit models algorithmically) and radically reduced time to process future models.

Hardware Level Copies of Parent Graphs

One aspect of optimisation, which can be applied to any embodiment, requires the generation of further graph models, from a current parent model. This aspect allows the ability to rapidly create further graphs in memory from a single parent.

Further graphs, or children, are generated so that they can be subsequently modified to create variability, which can lead to higher performance in the child relative to the parent as described herein. In order to be able to performance test many different child nodes rapidly, many children can be created in memory and ultimately stored in a persistent store, such as magnetic disk or SSD.

Traditional methods using software (via an RDBMS) require the parent graph model to be read in its entirety from persistent storage, processed in memory and then copied in to persistent storage and potentially re-read. Reading and writing from persistent storage is slow and inefficient.

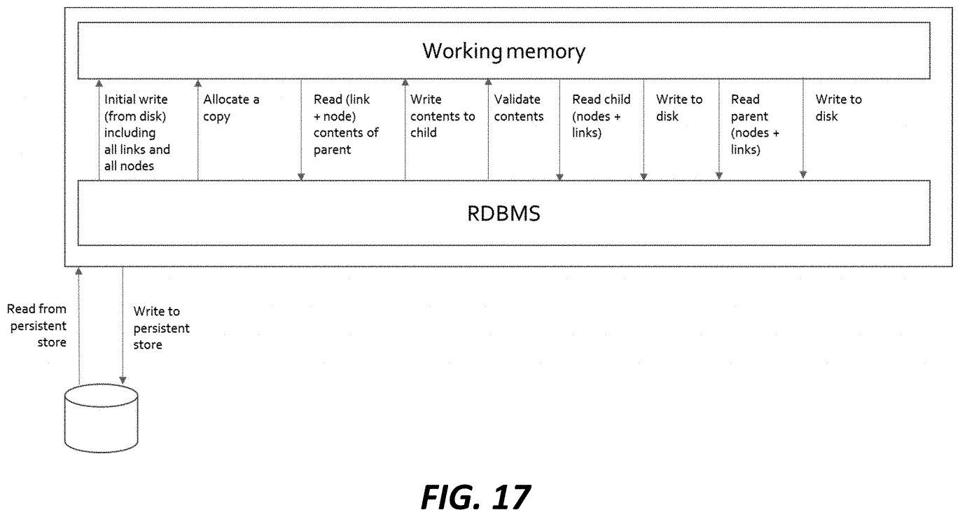

FIG. 17 is an example of a non-optimised process for generating child graphs. The method comprises the following steps:

Copy entire parent graph from current storage (e.g. magnetic media or SSD) into working memory. This includes the links and the supporting nodes, in separate tables.

Organise the records appropriately ready for copying (within the RDBMS).

Allocate sufficient space in the database management system.

Allocate working memory (e.g. RAM).

Copy records in working memory from the parent to the child address space (software mediated).

Validate copy integrity.

Commit the new record from working memory to disk (upon completion).

In this method, the RDBMS is required to perform the work of extracting data from disk to memory, performing the copy, running data integrity and consistency checks and then finally committing the record back to disk. This process, mediated through software, is computationally expensive because the processor is involved in reading and writing from disk and maintaining temporary copies as part of the process. This requires both processing and storage overhead.

Furthermore, copying every node and link through table copies in the RDBMS database is computationally slow and inefficient. Each read and write requires the entire database to be copied to local or remote storage, potentially multiple times in the event of database check point requirements.

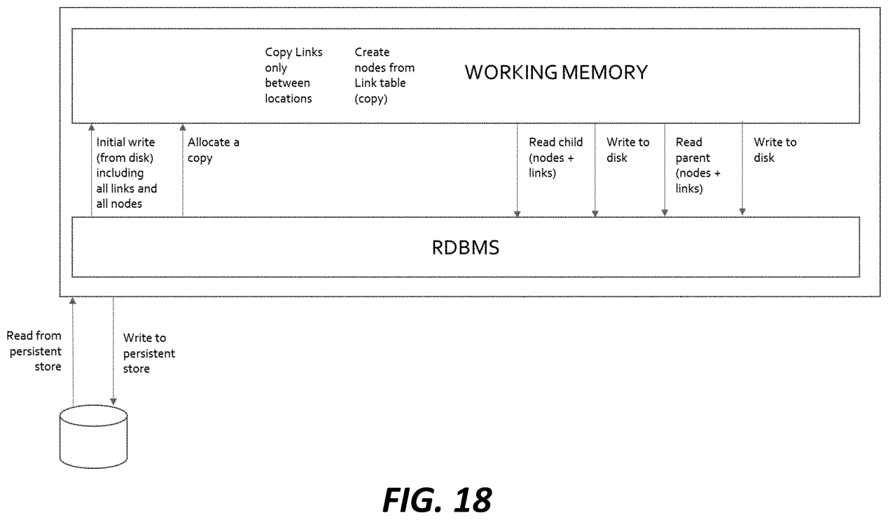

FIG. 18 illustrates an alternative method that allows many copies of a parent graph to be rapidly created directly in memory at the hardware level, yielding low overhead and high processing efficiency. The process only requires memory copies to create new children copies of a parent graph, without software processing.

A replication strategy is implemented in which the link table contains all data needed for efficient hardware level processing. This is used to perform a direct in memory copy of the links, which avoids the need to copy from a level 1 (L1) processor cache to a level 3 (L3) cache, each time employing significant performance overhead.

Generally, a child copy is created directly in-memory from the parent graph and then the nodes are recreated from the link content in memory. The method employs the following steps:

(Optionally) allocate sufficient working memory to store new child/children.

Copy the records from the parent persistent storage block or location to the child working memory block. The link table is copied (which also contains the node data), and this is performed memory block to memory block using a “memcopy” function, or any other equivalent function that copies blocks of data directly from a source address to a destination address, rather than using software to copy it to the software product via the operating system.

Parse the links of the parent and recreate the nodes/node table(s) from the link table node data (e.g. JSON data) of the parent stored within the record of the link.

Use the node data from each link to recreate node records in the children.

The method therefore involves copying the parent link table in working memory to generate a plurality of child models, and then using the link table to allocate node data to the children by copying the node data from the parent link table and recreating the child node table(s) from the link table.

An advantage of this method is that at no point are the records in the graph retrieved from disk to memory which is a traditionally very slow process. This avoids the need to perform slow SQL copies, and can be executed on fast hardware components. As a result of avoiding SQL queries, the execution can take place much faster, there is no need for additional local storage. This presents a significant benefit in speed of performance and storage, and allows many copies of children to be created in a short period of time whilst reducing the need to write to/read from persistent storage.

Processing Strategy for Testing Child Models

When determining whether child models represent improvements upon the parent model it is necessary to test them according to one or more performance parameters as described herein.

According to a first method, when a child model is created, all of the nodes and corresponding links can be copied from the parent to the child in memory. Then, all of the nodes that have been changed from the parent to generate the child are fully retested in every child.

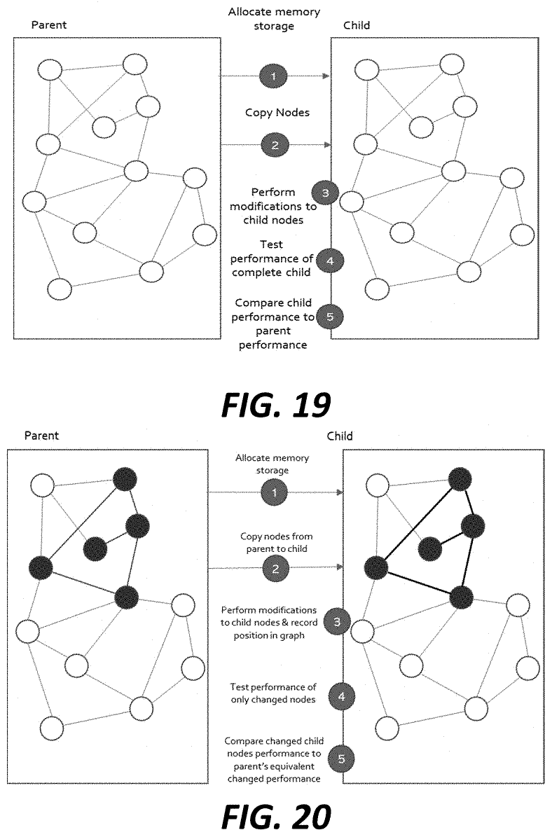

FIG. 19 shows an example of such a first method. The number of nodes and links in the parent may be identified, and sufficient space in memory is allocated for the new child. All nodes and links from the parent are then copied to the child. Changes are then made to the child to create the new child model, for example this modification can be performed according to the genetic mutation approach described below. All nodes and links in the child are performance tested, and the performance of the overall child is compared to the parent, using performance tests as described herein. If the child overall performance exceeds the parent, then the child is flagged as the new “winner”, meaning that it is a suitable replacement for the parent. The parent nodes may then be deleted from memory. In contrast, if the child overall performance does not exceed the parent then the child can be discarded and deleted from memory.

According to this first method, a large number of nodes which are not different from the parent are retested in every child. For child models that do not perform as well as their parent model, there is the potential for a significant amount of waste in both storage and CPU to test nodes which could be identified earlier as poorly performing.

It is possible, according to any embodiment of the invention, to reduce the number of nodes and links which have to be processed in order to assess whether a child model out performs the parent model from which it is derived, and is therefore a viable “winner” (i.e. represents an improvement in performance) over the previous iteration. Under this reduced processing strategy, according to a second method, only the nodes which have changed between parent and child are performance tested against the parent. Only the changed nodes are compared against the equivalent nodes in the parent. If the reduced nodes outperform the parent then the remainder of the parent nodes are copied to the child in memory.

FIG. 20 shows an example of the second method. The method may include the following steps:

The nodes that will be changed between parent and child are identified, based upon predefined criteria.

(optionally) Sufficient space is allocated in memory for only the changed nodes—the space allocated may therefore be less than the total space required for all nodes of the parent.

Only the nodes to be changed are then copied from parent to child, and the nodes of the child are then modified in any suitable manner (for example this modification can be performed according to the genetic mutation approach described below).

The performance of the changed nodes only are then assessed for the child, and for the parent (if not already assessed) and a comparison is made.

If the changed nodes in the child are higher performing than the parent then:

the remainder of the unchanged parent nodes are copied to the child model.

Else if: the changed child nodes are discarded and/or deleted from memory.

End if. The processing of worse performing models is reduced and the storage and CPU overhead of processing is also reduced by only copying to the child the nodes that change between parent and child. In particular, a greatly reduced set of nodes are copied from the parent to the child in memory, meaning that both storage space and the number of nodes which need to be performance tested are also greatly reduced.

Optionally, the method may only store the changed child nodes and links in working memory for each child. The relative performance of the changed nodes as compared to the parent are determined and if the changed child nodes perform better than the parent, then the whole parent is copied to the child, excluding the nodes equivalent to the changed child nodes. Equally it is possible to not actually copy the rest of the parent, but just create a pointer in the changed child nodes to the parent so it is only necessary to store a single parent model plus all of the changed child nodes. This means that the processing overhead and storage requirements for each child are improved. It is only necessary to store the parent and the changes applicable in the better performing child.

Self Optimisation Techniques

Examples of future self-optimisation will now be provided in more detail. This is performed where the simulation system is required to algorithmically build future improved model(s). In a first stage of optimisation, the first model can be provided (either by an external user/observer or through automated analysis) with an area to optimise which is currently underperforming. An example method for identifying areas that are underperforming and should be improved is described in detail in the section relating to unguided internal optimisation below, and may be used in any other embodiments to determine areas to be improved.

Where external input is required and the model is given an area to optimise, this is known as guided or directed optimisation. Alternatively, the model is given no external optimisation, only an area within the model to optimise or a particular domain of nodes. This is known as internal optimisation. In this instance, the model identifies the poorest performing parts of the model against a given set of performance metrics (e.g. identify the poorest performing parts of a vehicle movement system where the agility performance metric is performing below 40%).

Optimisation can further be classified as internal optimisation or externally-driven optimisation. Internal optimisation is somewhat like a hard disk defragmentation process. The system attempts to use the existing nodes and links and create a more optimal model by removing or reorganising existing link data, and/or changing data associated with the nodes, and testing the new configuration using the performance analysis. An external optimisation attempts to take external data and information from a variety of different sources and uses that data to replace existing internal node data or link relationships.

Guided Internal Optimisation

A guided, or directed, internal optimisation attempts to optimise a particular performance metric, domain or node without any external data. In other words, the system is told what to optimise (e.g. try to build a future model with improved performance for particular nodes) but not how. The optimisation may be performed as follows: an area of interest to be improved is identified in the current model, for example the user or observer may indicate what is needed to be optimised, e.g. by specifying a particular performance metric or a particular domain or node (s); for example, in the context of an electric vehicle, braking function is sub-optimal and needs to be refined and improved on a particular environment such as icy terrain; node data records are collated under the current operating model for that performance metric (or metrics)—this may take the form of node traversal as described above; the collective performance of the relevant nodes is assessed using any of the performance assessment methods described above; future models are generated, for example according to any of the methods described herein for doing so; each future model is performance tested against the specified metric or metrics according to the performance assessment techniques; the future model that performs the best on any specified performance metric number (one or more performance metrics could be specified) is selected (manually or automatically using an algorithm).

The step of generating future models may be performed by randomising one or more elements of the model, or using a heuristic. Under the randomisation method, data inside nodes is modified. The modification could be applied to predetermined node data types, with the value of the predetermined node data type being modified in a random fashion; for example, for a model of a vehicle, a node's data records representing gearing could have ratios changed or braking rates modified. Furthermore, links could be modified randomly to change the way that parts of the model interact with others, resulting in behavioural changes of a group of nodes or wider part of the model. Link weights could be modified up or down to represent closer or wider coupling between relationships; for example wheel nodes in an autonomous vehicle may decouple or behave in tandem when their coupling links are modified through randomisations of their link values.

2) Guided External Optimisation

A directed external optimisation attempts to optimise a particular performance metric, domain or node with reference to external data providing information on external domain or node type data. In other words, the system is tasked to optimise a specific type of node and their links and has access to external sources of model data which may provide more optimal solutions. For instance, in the context of a modelled server based system the optimisation system may be requested to optimise applications that offer a particular set of capabilities and the servers that they operate on.

The optimisation may be performed as follows: an area of interest to be improved is identified in the current model, for example the user or observer may indicate a particular facet of the model that needs to be optimised, e.g. by specifying a particular performance metric or a particular domain or node(s); node data records are collated for the current model for that performance metric (or metrics), domain or node type—this may take the form of node traversal as described above; depending on the optimisation strategy, external data is pulled in specifying a model relating to other subjects but having the same set of node relationship types. The model relates to other subjects by virtue of having different node data to the current model. This local strategy varies for each different entity type being optimised. There are local optimisation rules applied.

Performance assess the current model (using the any of performance assessment methods described above); create a new model with the external data replaced over the current data; performance assess the new model; if the new model performs better on any specified performance metric, then favour/select the new model; optionally, if the model is less optimal then build the model but mark as a likely reject.

In relation to the above optimisation, and as an example, if a road-based autonomous vehicle having a particular configuration of nodes (e.g. tyres node in relation to wheels node) is performing badly in a snow environment, a different model is adopted, such as a tractor model in which the wheels nodes and tyre nodes have the same relationship but due to a change in the data contained in the nodes (e.g. change of type of wheel node), the resulting performance in snow is significantly improved.

Unguided Internal Optimisation

An undirected internal optimisation attempts to optimise the model generally without any external data. This is where the system is not informed a priori what to optimise and has no way to make informed guesses and try to optimise different areas of the model automatically. The model has only access to internal nodes and link data and is tasked with optimisation of link-based relationships and nodes that already exist. This is the most challenging of the optimisation areas. In this scenario, the optimisation system may iterate over all areas of the model and attempt to optimise areas that are not performing.

The first step is to identify those areas which are underperforming. A proposed method for this is to validate the performance of the model in a particular environment (via the performance assessment methods described previously). Where performance is low (relatively speaking as compared to a history of values) the optimisation system could ascertain that self-optimisation is required. For example, in the context of an autonomous vehicle, if a sensor records forward propulsion speed and stores the history over time, when the AV starts recording relatively low values for a sustained period of time, the model could detect that the nodes related to propulsion are not performing. In this instance, all nodes related to the propulsion system can have gradual randomisations to change their configuration. Each time, performance is retested until propulsion starts to record acceptable relative performance. If, after randomisation, performance is not improved, then the method may continue to randomise until a configuration is found which does work.

Examples of how the optimisation may be performed are as follows:

model analysis starts in one domain (particular node types) and cycles through each subject type in the current model, the subject being a particular set of nodes of a common type or that relate to a collective part of the model; for each subject type: performance test the current model for that subject; execute the subject's associated optimisation heuristic to determine better performing model;

End Subject Optimisation Heuristic

End method

The optimisation heuristic is specific to the subject. There are many types of appropriate optimisation heuristics that may be possible, depending on the subject being optimised.

As an example, the optimisation heuristic attempts to identify overlapping nodes that provide equivalent functionality within the system. The heuristic method may comprise: collate all the nodes for that particular heuristic; identify overlaps or ways of compressing the node families for the current subject; develop different models for each outcome on that node family; performance test each output model (using any of the performance assessment methods described above); if a model is more performant then retain the model; end whole optimisation.

Unguided External Optimisation

An undirected external optimisation method attempts to optimise the model based upon access to external data. This is where the model is neither guided on, nor informed of, which areas to optimise but has access to external data sources to test different model configurations. Such a method may include the following steps:

Find/select a subject area to be optimized

Performance test using performance assessment metrics (as described previously)

Obtain and integrate equivalent external data

Overlay external node data on to existing nodes

Replicate any links as necessary

Performance test the new model (using any of the performance assessments described above)

If the model exhibits higher performance then save as a future model

Example Optimisation Process

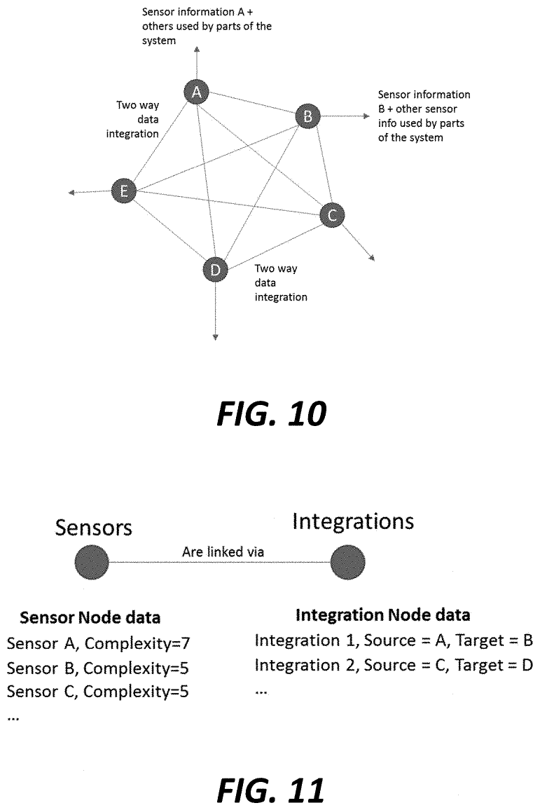

A particular example of an optimisation process will now be described in relation to FIG. 10. In this example, the system comprises five sensors/environmental recorders A to E. Each sensor may provide data related to the system environment from different viewpoints, and each collates information regarding a particular aspect of the environment. This information needs to be harmonised and integrated into a single representation (e.g. a single integrated and coherent representation which is complete and incorporates all of the sensors' respective views of the environment). Each sensor also provides some information to a different part of the system model, which requires specific types of sensory information. Frequently, though, each sensor needs to augment its own information with some or all information from other sensors in order to provide meaningful or useful data elsewhere in the system. In order for each sensor to incorporate information from every other sensor, information must be integrated from other sensors. As each sensor has a full and rich data set, integrating data from each sensor in a way that is meaningful is complex. Furthermore for a complete view of the environment, every sensor's data needs to be integrated in a complex way.

In this example, the parameter to be optimised is the complexity of the system, in order to reduce duplication of system components for example. From a systemic complexity perspective, five nodes and ten integrations between nodes are required. Weightings can be applied to each node, the weightings being indicative of a level of complexity from a lowest possible value to a highest possible value. Each integration point, being a combination of data from two sensors, may have a resulting complexity. This may be a combinatorial complexity derived by adding the complexities from the respective nodes, or a multiplicative complexity derived by multiplying the complexities from the respective nodes, for example. By determining the resulting complexity values for each integration point, it is possible to determine a total complexity score value for the model by combining them, for example by adding them all together.

An aspect of the model for representing this type of relationship is shown in FIG. 11. Two nodes are used, one representing the sensor data across all sensors and another representing the various integrations between sensors. The complexity parameter values associated with each sensor are also stored in the table associated with the sensors node. Each node in the model of FIG. 10 becomes a data point or record in the sensors node. Each integration in the previous model becomes a data point or record in the integration node.

A suitable optimisation for this type of problem is to measure the relative complexity of the model. This can be done by assessing a complexity score against a maximum level of complexity possible (for example if each node were at a maximum complexity level, e.g. level 7, then maximum complexity would be 10*7*7=490). If the model passes a particular threshold complexity score, then the model is to be optimised. For example a model may have a complexity score of 296, which represents 60.41% of the maximum complexity and for a threshold of 60% this means that an optimisation heuristic is applied.

The heuristic may be performed as follows. Rather than integrate different complex sensor information in real time and then have different parts of the rest of the system receive data from each sensor's unique representation, a single, expanded representation (A′) is created that applies to all sensors. This drastically reduces the need to integrate data from multiple sensors in real time. The model requires that one particular sensor representation (A′) can be extended to hold a sufficiently broad amount of data that will provide the required sensor data to other parts of the system with minimal augmentation.

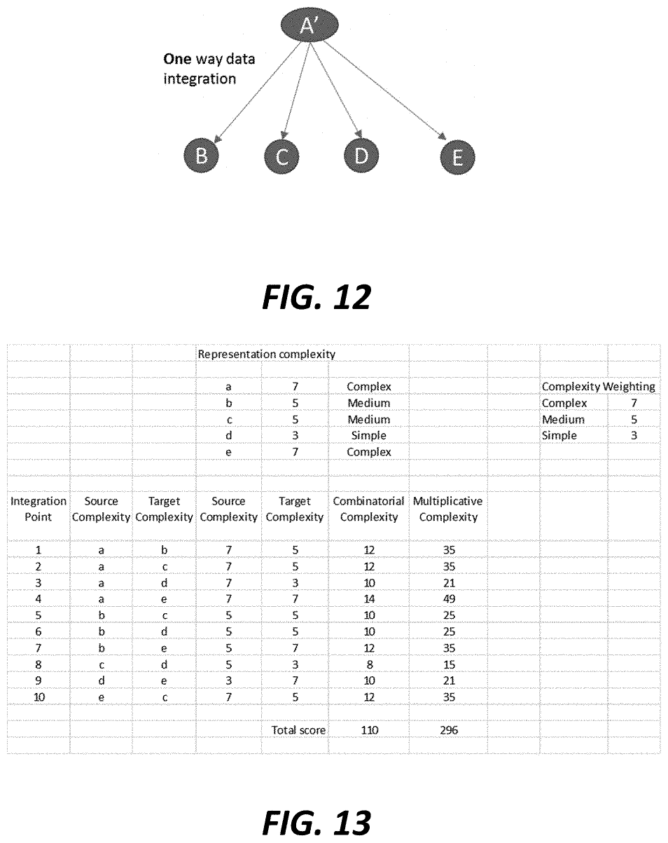

FIG. 12 shows an example model of the expanded representation (A′). The sensor A′ is used as the master primary sensor which provides information to the other sensor nodes. The remaining sensor nodes B to E augment to the sensor A′ model data that they receive, for example in an additive manner.

As a result of changing the system model, there are significantly fewer integration points to achieve the same outcome. Furthermore, the types of integration required are combinatorial as opposed to multiplicative. This is because the primary representation is only added to subsequent sensors. There is no real-time, two-way complex integration of competing information required between sensors. The total resultant saving of complexity is >50%.

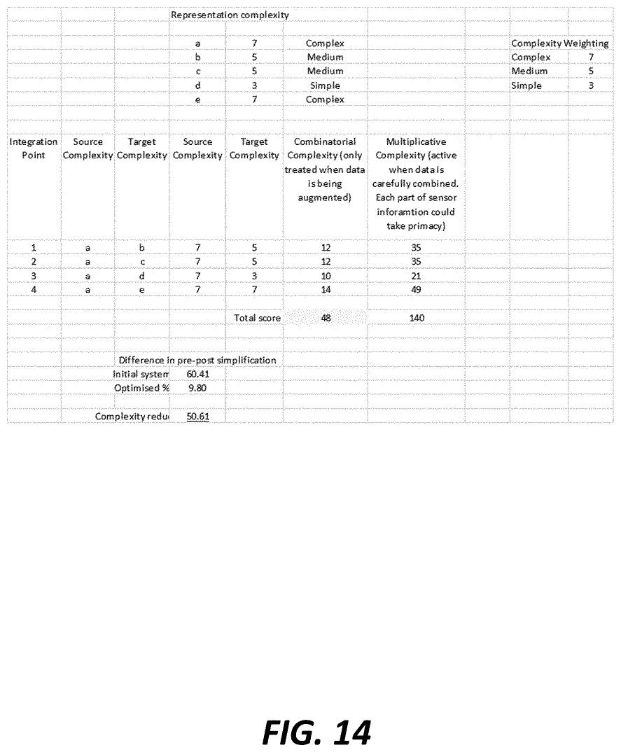

Examples of complexity weighting calculations are shown in FIGS. 13 and 14 for the models of FIGS. 10 and 12 respectively.

Genetic Optimisation

A further refinement of the optimisation process is to allow the system to build a series of models which steadily improve over time. These can be created using an evolutionary algorithm-based approach to evolve a series of further optimised future models.

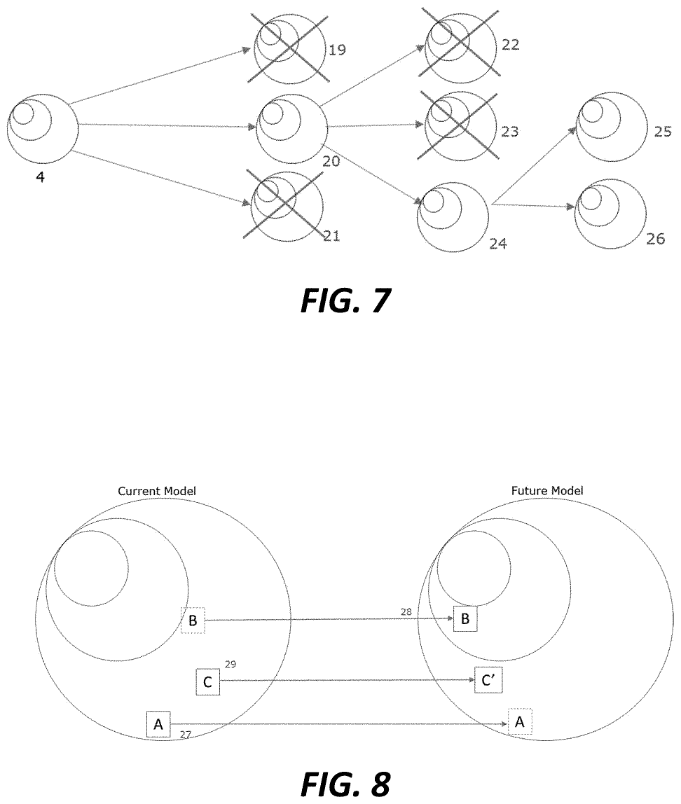

Having rated and ranked each future model against a set of performance criteria, optionally the method then selects the “fittest”, or best performing, model (defined as the model which best supports specified future performance requirements, or has the best score according to one or more performance parameters). The fittest model may then be chosen to become the seed for the next generation of models. This is illustrated in FIG. 7 (see reference 20).

Other models 19, 21 in the first iteration are rejected. Model 20 is then used to create similar future models, each of which are also then tested against the same set of performance criteria. As before, the highest performing (fittest) model 24 of the second iteration is selected to reproduce (or create future generations) whilst the other models 22, 23 are discarded. This process continues until an optimal model has been created which performs higher than all previous models and the cost to reproduce models, i.e. to perform further iterations, does not warrant the positive delta increase in performance of the models.

This takes an evolutionary algorithmic approach in that models are created and tested for performance. The strongest survive and reproduce and the weakest do not survive to the next stage. However, each iteration of model creation does not introduce a random mutation to each model. Instead, each model is modified against a set of hypotheses that are assessed by the method using a reference model (sometimes referred to as a “seed organisation”—discussed later) which may be held externally to the system and which contains external information that can be imported. These follow the method described below for automatically creating and planning changes within the model.

Some of the terms used when referring to the genetic optimisation technique will now be described. A “generation” is a particular iteration of models. In each generation, any particular model created is known as a “child”. The genetic optimisation process is one of creating a new generation of child models, each of which differs slightly, then selecting the one which performs the best according to one or more of the performance parameters and then discarding the other models. From the single remaining model, further generations are then built to try to build even more successful model(s). At each stage of optimisation a group of children are developed, each of which is slightly different. Only the most successful is allowed to survive.

An example of the process will now be described:

A minimum improvement threshold is set. Once the minimum improvement threshold is reached the genetic improvement algorithm stops running. This means that when the models are no longer improving sufficiently between iterations, the process stops iterating. The minimum threshold may be set as an absolute performance parameter threshold, or as a threshold level of change relative to the best model generated in a previous generation (such as the immediately preceding generation).

A current model's performance is tested and recorded. For example, performance is analysed using one or more performance parameters as described herein.

A copy of the current model (called “current”) is taken.

An iterative loop is then enacted, which comprises the steps of:

Create future model generation stages using one of the future generation types above from “Current”. The future models may be generated using any of the optimisation techniques described herein.

Test each model for performance based on a particular characteristic of interest (e.g. complexity or efficiency)

Discard all models other than the best performer (the “winner”)

Calculate performance improvement=(winner performance−“current” model performance)

If the performance improvement is less than an improvement threshold (i.e. if the best performer does not significantly improve performance) then exit the loop, otherwise:

Set “Current” to winning model to continue to iterate

End loop

End method

Genetic Optimisation Performance Enhancement

According to a first method of genetic optimisation, all nodes may be copied from the parent to the child model and then all nodes of the child are fully tested. Only once all of the nodes in the child are fully performance assessed is the result compared to the parent's performance. The performance algorithm tests all nodes—either all of the nodes of the model, or only the changed nodes under the above described method “Processing Strategy For Testing Child Models”.

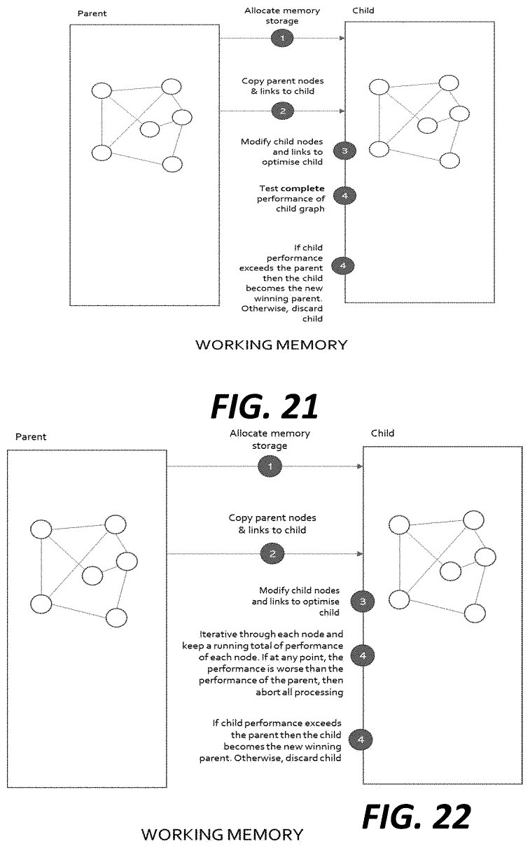

FIG. 21 shows an example according to this first method of genetic optimisation. The method includes the steps of:
(optionally) Allocating space in working memory for each child based on the size of the parent.
Copying nodes from the parent to each child's address space.
Making changes to link and node data for the child, as previously described, to create a variation of the parent model.
Performance test the entire child based on one or more performance metrics, as previously described.
Compare the performance result of the child to the parent
If the performance of the child exceeds the performance of the parent, then:
Flag the child as the current “winner”—i.e. the best performing model found for that iteration.
Remove/discard the parent from memory.
Else If the performance is worse than the performance of the parent then:
Discard/delete the child model from memory.
End If

According to a second alternative optimisation method, nodes in the child models are simultaneously performance assessed against the parent on a node by node basis (rather than in bulk). At the point that the child nodes performance reaches a low threshold and the child is deemed to be worse than the parent, all processing of the child stops.

FIG. 22 shows an example of the alternative method, which may include the following steps:

(optionally) Allocating space in working memory for a child based on the size of the parent (or allocate space only for the nodes to be changed as described in relation to “Processing Strategy For Testing Child Models”).

Copying the nodes from the parent to the child's address space.

Making changes to link and node data for the child, as previously described, to create a variation of the parent model.

Create a pointer in the child and the equivalent nodes at the same position of the parent. The pointers indicate progress through the path of the parent and the modified nodes. This allows tracking of like for like performance of nodes through both the child and parent models. The pointer may therefore be a position pointer between parent and children to ensure the relative performance is performance at the same point for both.

For each node that has been changed:

Check the performance of the changed node in the child.

Allocate ongoing performance of the changed nodes to the equivalent parent nodes.

If the sum of the ongoing performance metric for the child is lower than the total performance metric of the parent (indicating a worse performance for the child), then:

Stop processing further nodes of the child.

Discard the child model.

Delete child nodes from memory.

End If

End For

In essence, an iterative run, or traversal, through each node of the child is performed, with a running total of performance being maintained for each node. If at any point the performance of the child is worse than the performance of the parent, or the equivalent nodes of the parent, then further processing of the child is aborted, and the method can move on to the next child. If child performance exceeds the parent performance then the child becomes the parent for the next iteration (unless there are additional child models to be compared for that iteration, in which case the highest scoring child can be used).

At the point that the nodes are modified and stored for each child, the performance of the nodes are calculated on the fly. Optionally, when the algorithm identifies that the performance of the child is so poor (for example at mid-point of all its new node and link processing), if it is not possible for the child to exceed the performance of its parent, the processing is halted entirely and none of the nodes for that child are stored.

Embodiments that implement this method may have the advantage that any unnecessary processing of children that will never perform well is stopped at the point that the performance falls below that of the parent. This means that both CPU and memory performance are improved over the existing method by reducing any processing overhead of poor performing models.

Genetic Optimisation—Alternative Model Generation

Performance assessing a model may be performed in the manner described in relation to FIG. 19. This may be generally based on an approach whereby the performance of the overall model is determined by links and nodes which have a set of measures or weights between each link. The weights determine the strength of the relationship. Over time, the links are modified organically, re-tested against the parent and assessed for subsequent improvement or decline.

As an alternative, one or more external libraries of stored configurations of specific nodes and links may be pre-cached in storage. These sub-model configurations may be selected for storage in a library as they are known to perform well in certain performance scenarios. Each stored sub-model includes the relevant node data, links data and their associated performance data. Once created, a given child model assumes the pre-configured sub-models from the libraries, replacing existing equivalent nodes. The performance of the sub-model its combined with the performance of the remaining model to provide an overall performance of the child model. The performance metric of the child model is then compared to the parent model. If the child model's performance exceeds the parent's performance, then it becomes the new high performing “winner” and is used as the reference point for subsequent generations. If the child model's performance does not exceed the parent, the next cached model is selected, replaced in the child model and performance of the new overall model tested. This continues until all suitable cached models, or just the models that are relevant to the particular scenario, have been examined.

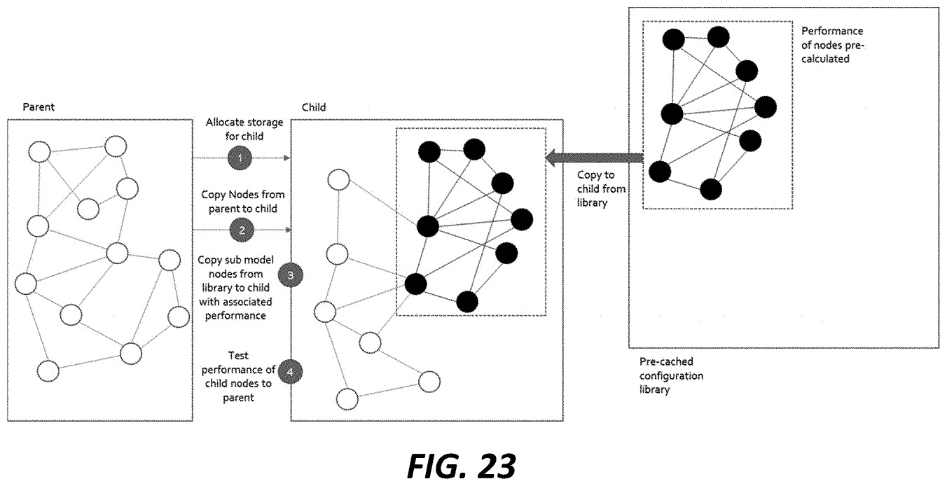

FIG. 23 shows an example of such a method. The method may comprise the following steps:

For each relevant model in the cached library:

Replace the equivalent nodes in the child with the cached sub-model;

Combine the performance of the new child's existing un-cached nodes (i.e. the portions of the child node that have not been replaced) with the performance of the cached sub-model;

Compare the performance metric of the resulting new model to that of the parent's, or to a highest performance network's performance;

If the child's performance exceeds the parent, then Mark the child as the new highest performing model;

End If

End For

The performance metric determinations and comparisons can be determined in any suitable way, such as the traversal method described herein.

This method enables the system to rapidly test new configurations incorporating known solutions of high performance rapidly without the overhead of having to parse all nodes of a model. Only the new nodes alongside pre-cached sum-model configurations need to be stored.

Many different configurations that result in more optimal performance of the system can be tested rapidly without the need to compute them one by one each time. This saves compute time generating new children which may not perform but also results in far greater performance testing of new children, as no performance calculation of the existing nodes of the sub-models is required. The performance metrics of the sub-models are pre-calculated once and stored, and can be used on many different children with no further performance calculation required.

Change Detection

Once a series of future models and related current model have been defined, the aim of embodiments of the invention may be to determine the changes that must be taken to move from the current model to the desired future state represented by the determined future model, employing a fully automated machine learning process to do so. The method may be implemented to build a complete change inventory with the resources identified to realise a future state purely from the data in the model, optionally supported by external data captured in real time. Such change detection can be applied to machine learning and any system representing a model to be improved, such as image recognition systems.

To move from the current to future model(s), a change detection algorithm operates which detects which node records have been either added, deleted or updated between each respective model and builds up a library of changes. This is used to build up a change inventory.

A node is treated as a real-world entity that exists at a point in time. The nodes represent an element of the system, and optionally other features such as its domain and/or other parameters at a point in time. Node records can therefore be consistent and retained between different models at different points in time representing items in a system that have not changed.

Each node contains a set of records or data points which have either been added or deleted at some point in time to each model. This is illustrated in FIG. 8. Changes to node data represent either optimisations to the existing model (something being changed to try to improve the performance of the model) or decline in performance (unexpected changes or deletions which could negatively impact the performance of the model). Future models should show an improvement in performance against the current model over time against a desired set of future performance criteria.

Node records which appear in State A (current time) that do not appear in State B (at a later point in time in a future model) are treated as if they have been removed. Node records which appear in State B but that did not exist in State A have been removed. Any data in any node between State A and State B is considered to have been updated.

A change detection update data structure (e.g. a table) may then be generated. As shown in the example of FIG. 8, a resulting change detection update table would be generated as follows:

| Current | Future | Change |
|---|---|---|
| A | none | A removed |
| none | B | B added |
| C | C′ | C changed |

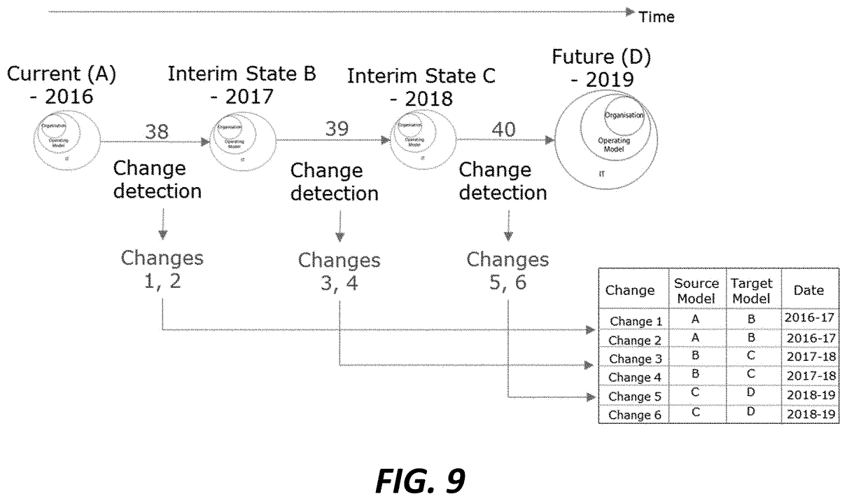

Changes can be built up between a series of interim models developed over time. Between each model (representing a point in time), changes are collated into a change table. Over time these result in significant changes to the model that can be accommodated and planned. An example of this is given in FIG. 9.

An example of the change detection method is provided below:

For each node data point in the current model:

Check to see if it exists in the future model

If not, add to the Changes table and mark as ‘deleted’

If it does exist:

Check to see if its contents are identical

If not identical:

Add to Changes table and mark as ‘amended’

End If

End If

Move to next data point

2) End For

3) For each node data point in the future model:

Check if node in future model is in the current model

If no, add node to the Changes table, mark as ‘addition’

End If

4) End For

The method of change detection provides a materialised view/cached set of data points, which are capable of being held entirely in memory.

Example System

An example system that is modelled will now be described. The example is an autonomous vehicle (AV) that learns to navigate through an environment and has the ability to improve its performance over time so that it becomes more successful at navigating in different environment types and conditions. Using measures of current performance, the model identifies aspects which perform sub-optimally and aims to change the model in order to improve the performance of the AV in its environment.

Performance of the AV is a function of a set of criteria such as speed, traction, ability to find the most sun at points in time of low energy (for solar powered vehicles), ability to climb uphill, etc. Performance is measured by analysing a series of performance measures detected via the sensors, integrated into a single view and defined as a function of the gears, actuators and wheels and other nodes defined within the motion domain (i.e. all nodes that are involved directly or indirectly with motion).

Example vehicle representation nodes are:

Wheels

Sensors (scene/environment, speed, direction)

Gears

Integrations (node representing the need to integrate data between nodes)

Actuators

Each vehicle is represented by a series of data records between linked nodes. For example, a particular vehicle could have 6 wheel data records, representing different variants of valid wheels, 6 actuators, 20 sensors detecting different factors in the environment and 100 integration records each representing a data integration feed between sensors so that a fully integrated view of the environment can be provided.

As the vehicle moves, it is able to assess its performance by integrating data across a series of sensor values. The integration data points define which sensor data sets need to be integrated to define a holistic view of the environment. These are integrated to provide a holistic view of the performance of the AV at any point in time.

The objective of the example is to enable the model to self-assess areas of the model which are not performing well within its environment. For example, particular wheels are not suited to certain types of terrain and therefore do not give good forward motion performance as measured by the sensors.

The goal in this example is to define a configuration of new wheels (perhaps two larger front wheels for example) with a different set of actuators which enables better motion in a particular environment.

In some cases, the AV will be operating entirely autonomously within its environment and will need to self-test performance of nodes and seek to improve these with no external guidance. This might involve different functionality of actuators, guided by sensors in different ways to improve performance.

In some instances the vehicle might receive external guidance from external observers that allows the model to be informed which parts are under performing and are therefore subject to be improved.

Any parts that are to be improved result in changes to the configuration of the vehicle which are then measured for performance. Any configurations which result in a performance increase are maintained whilst configurations which decrease environmental performance are discarded.

While the example model is very simple, with a small number of representative nodes, very complex AVs can be represented by a model with many highly interacting sub components which result in a viable vehicle.

The nature of the vehicle requires rapid analysis as the vehicle is traversing through an ever-changing landscape and environment. As such, processing performance and the ability to rapidly assess new models is vital to the ongoing success of the vehicle.

Various examples of systems have been provided throughout the specification. Despite any examples, it will be appreciated that any embodiments of the invention can apply widely to any type of system that may evolve over time. This may include any complex system that is capable of being modelled with an undirected, weighted, fully connected graph, that is operating in a real, dynamic, ever-changing environment where change and performance of the model is important, and may include organisation structures, including corporate organisational structures. The representations of the model will suit any complex system that needs to evolve itself over time and test its performance algorithmically with limited external guidance other than environmental inputs. Such appropriate complex systems could include semi organic organisms, or organisations, operating in complex environments.

Generally, embodiments of the invention may optionally be implemented for models of systems having at least three nodes and at least ten node data records per node. Such models are sufficiently complex to benefit from implementations according to embodiments of the present invention.

Any embodiment of the invention may be implemented in one or more software modules executing on one or more computer devices which may be networked together locally or over a wide area network such as the Internet as appropriate.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A computer implemented method for use in self-optimising a complex, time varying system, the method being performed in relation to a first model of the system, the first model being a weighted graph-based model of the system, the model comprising:
a plurality of nodes, each node representing an element of the system and comprising one or more node data records, each node data record representing an instance of the element of the system and one or more of its associated properties;
a plurality of links connecting pairs of nodes, each link indicating the relationship between a pair of nodes:
the method comprising:
performing a query to determine at least one property of the system by performing a traversal along a path from a start node to an end node of the first graph via one or more intermediate nodes according to the links, which are stored in a common data storage structure, the traversal comprising collecting one or more data records associated with each of at least the start and end node and determining the property of the system based on the collected data records.

2. The method of claim 1, wherein the data storage structure is a link table defining directed and/or undirected links between the pairs of nodes, the link table comprising a plurality of records, each record being a specific instance of data connecting a source node, identified according to a source node identifier, to a target node, identified according to a target node identifier.

3. The method according to claim 1, wherein the common data storage structure also includes the node data records.

4. The method of claim 3, wherein the node data records are stored in the common data storage structure in a compressed/storage optimised format.

5. The method of claim 1, wherein the model further comprises: a link-type table being a table that constrains the number of paths that can be traversed by defining valid links between pairs of the nodes.

6. The method of claim 1, further comprising the step of loading model data from one or more external sources into the nodes and/or into the weights in the links between nodes and node data.

7. The method of claim 1, further comprising the steps of:
determining at lease on of the properties of the system for each of one or more alternative candidate improved, weighted, graph-based models of the system;
selecting one of the alternative candidate models based upon the at least one property; and
determining the difference between the first model and the selected candidate model by comparing at least a subset of the nodes of the first model with at least a subset of the nodes of the selected model.

8. The method of claim 7, wherein the one or more data records associated with each node includes a data record indicative of a domain to which the node belongs, such that the nodes are each contained within one or more domains of a set of hierarchically structured domains.

9. The method of claim 8, wherein the query traversal path is limited to nodes within a particular domain.

10. The method of claim 9, wherein the property of the system is a performance metric and determining the performance metric comprises:
when traversing the path from the start node to the end node, collecting data records of a predetermined type, the predetermined type being defined by the query;
combining the values of the data records collected for each traversed node; and
scaling and/or normalizing the combined value,
wherein selecting one of the alternative models based on the performance metrics comprises comparing the determined performance metric for the first model with corresponding performance metrics values for the one or more alternative models.

11. The method of claim 10, wherein scaling the combined value comprises:
determining the highest value and the lowest value that the combined values of the data records of the predetermined type may reach over the traversal path;
scaling the combined value based upon the highest and the lowest values.

12. The method of claim 11, wherein the method further comprises generating the one or more alternative graph-based models by:
altering the first model; and/or
obtaining data from an external reference source and generating a model using the external data.

13. The method of claim 12, wherein the first model is altered by:
replacing one or more nodes in the first model with a sub-model comprising one or more nodes from a predetermined collection of sub-models, the sub-models each comprising predetermined data indicative of the predetermined property of the system for the sub-model;
determining for the altered first model, the at least one property of the system by determining property of the sub-model;
comparing the combined property to the corresponding property for the first model; and
based on the comparison, storing the altered first model or repeating steps with a different sub-model;
comparing the combined property to the corresponding property of the first model; and
based on the comparison, storing the altered first model or repeating steps with a different sub-model from the predetermined collection.

14. The method of claim 13, wherein the first model is altered by creating a plurality of copies of the first model, the method further comprising generating a plurality of copies of the first model by:
copying the parent link table from its current storage to working memory; and
generating a plurality of copies of the link table by copying the parent link table in the working memory.

15. The method according to claim 13, wherein the first model is altered by:
identifying the nodes of the first model to be changed to generate the one or more alternative graph-based models;
allocating sufficient space in working memory to accommodate the nodes to be changed;
copying from the first model, into the allocated space in working memory, the node data for the nodes to be changed;
modifying the copied nodes;
determining, for the modified nodes only, the at least one property of the system;
comparing the determined property to the corresponding property for the first model; and
based on the comparison, copying the node data for the remainder of the nodes into the working memory or deleting the node data for the changed nodes from working memory.

16. The method of claim 15, further comprising performing an evolutionary optimisation by:
generating a set of alternative graph-based models from a seed model or by applying one or more variations to a current model;
determining at least one performance metric for each of the models in the set;
determining the best performing model within the set based on the performance metrics; and
repeating the steps a plurality of times, replacing the seed model, or the current model, with a subset of the best performing models each time.

17. The method of claim 16, wherein the evolutionary optimisation further comprises determining the improvement in the performance metric from the best performing model in the current set of alternative graph-based models over the best performing model in the previous set, and halting the evolutionary optimisation when the improvement, according to the performance metric, is beyond a predetermined threshold.

18. The method according to claim 17, wherein determining at least one performance metric for each of the models in the set comprises:
traversing through each model in the set and determining the performance metric cumulatively based at least on the nodes that have been varied over the current model;
for each node traversal, comparing the cumulative performance metric for the model with the performance metric for the current model;
ceasing further processing of the model currently being traversed if the cumulative performance metric indicates a lower performance than the current model.

19. The method of claim 18, wherein determining the differences between the first model and the selected model comprises:
For each data record of at least a subset of the nodes in the first model:
determining if a corresponding data record exists in the selected alternative model; and
updating a change table to indicate whether: the data record exists in the alternative model; if it has been modified; or if it has been deleted.

20. The method of claim 19, wherein determining the differences between the first model and the selected model comprises:
for each data record of at least a subset of the nodes in the selected model:
determining if a corresponding data record exists in the first model; and
updating the change table to indicate whether the data record exists in the first model.

21. The method of claim 20, wherein the model further comprises:
An analytic query path data structure which defines one or more pre-defined paths between pairs of nodes; and
wherein performing a traversal along a path further includes:
looking up one or more records within the first node of one of the pre-defined traversal paths; and
storing records located within the links of at least the first and last node in the pre-defined traversal path.

22. The method of claim 21, further comprising the step of:
filtering stored records while performing the traversal, or after the traversal, if they meet a predetermined condition.

23. A method of claim 7, further comprising adjusting one or more parameters in a physical system in accordance with the determined differences between the first model and the selected candidate model.

24. The method of claim 23, including a computing device.

25. The method of claim 23, wherein a computer program comprising instructions that, when executed by a system comprising one or more computer device, causes the system to carry out the method.
